(19) United States
(12) Patent Application Publication
(10) Pub. No.: US 2015/0044527 A1
(43) Pub. Date: Feb. 12, 2015

(54) BATTERY CORE HERMETIC CASING

(71) Applicant: Apple Inc., Cupertino, CA (US)

(72) Inventors: Bernd J. Neudecker, Los Gatos, CA (US); Brian C. Menzel, Sunnyvale, CA (US); Gregory A. Springer, Los Altos, CA (US); Shawn W. Snyder, Santa Clara, CA (US); Timothy W. Scales, San Francisco, CA (US); Victor William Santini, Mountain View, CA (US)

(21) Appl. No.: 14/455,591

(22) Filed: Aug. 8, 2014

Related U.S. Application Data
(60) Provisional application No. 61/864,342, filed on Aug. 9, 2013.
(60) Provisional application No. 61/878,484, filed on Sep. 16, 2013.

(51) Int. Cl. H01M 10/42; H01M 2/08

(52) U.S. Cl. CPC H01M 10/4257; H01M 2/08; H01M 2010/4271
USPC 429/61; 429/156; 429/159; 429/246

(57) ABSTRACT

A battery cell core is hermetically sealed inside a casing, with conductive paths formed in the casing that individually connect cell subsets of the core to a battery management circuit for detecting individual failing cell subsets and for changing the battery output voltage by forming series/parallel connections between the cell subsets. In one version, the casing has a metal can with an opening of the can being sealed by a non-conductive cap that is sealed and bonded along its periphery to the can walls. In one aspect, the cap has edge metallization along its periphery where it is sealed to the can walls. In another aspect, the conductive paths are formed in the non-conductive cap. Various other embodiments are also described and claimed.

This non-provisional application claims the benefit of the earlier filing dates of provisional application Ser. No. 61/864,342 filed Aug. 9, 2013 and Ser. No. 61/878,484 filed Sep. 16, 2013.

An embodiment of the invention relates generally to batteries and more specifically to the hermetic packaging or casing of battery core structures. Other embodiments are also disclosed.

### BACKGROUND

Batteries are made up of one or more electrochemical cells that form their core structure, where each cell can include an anode and a cathode separated by an electrolyte and/or other components. For example, a lithium-ion battery cell may include a cathode having a layer of lithium cobalt oxide, a separator layer placed over the cathode, and an anode placed over the separator layer. One or more of such layers may be sensitive to environmental exposure including moisture and oxygen. As a result, an assembly of one or more cells can be cased or packaged in a hermetically sealed manner, in order to protect the assembly against moisture, oxygen and/or other environmental components that may ruin the core structure.

Conventional battery core casing involves placing a battery core between a lower pouch sheet and an upper pouch sheet, then hermetically sealing the pouch sheets. The pouch sheet material is a metal layer or foil laminate, i.e. a metal foil laminated between electrically insulating layers. To reduce space that is consumed by the pouch sheets, the edges are folded. However, the folded portions still add to the horizontal dimensions of the finished battery. Also, the seals themselves are an organic diffusion region and not as effective as the metallic regions. In addition, the folded portions may leave empty space between the core and the inside of the pouch, further increasing the horizontal dimensions. This is particularly of concern for thin film batteries which are composed of thin materials in the nanometer or micrometer thickness range and which allow the finished battery to be only several millimeters thick, while having a length or width, for example, on the order of tens of millimeters. Such a battery may need to fit within a very limited space in a consumer electronics device, for example, into which the battery is incorporated. Any increase in the dimensions of the finished battery, and particularly in the regions inside the casing that are not occupied by energy storing or active cell material, will reduce battery energy density (unless the core increases in size proportionally).

### SUMMARY

An embodiment of the invention is a battery having a hermetically sealed casing inside which a battery cell core is contained, the core having multiple cell subsets, each cell subset comprising at least one battery cell. The casing has conductive paths formed therein through which each cell subset is individually connected to a battery management circuit.

In one embodiment, the battery management circuit senses voltage of each of the cell subsets individually, through the conductive paths. In another embodiment, the battery management circuit uses the conductive paths to connect any one of the cell subsets with another one of the cell subsets, in series or parallel, e.g. in response to sensing a failing cell or receiving a command from an external system to change a primary output voltage of the battery that may be provided through a pair of external battery terminals.

In one embodiment, the hermetically sealed casing comprises a metal (metallic) can in which the core is held. A non-conductive cap covers an opening of the can, with a periphery of the cap being bonded to the can along a boundary of the can opening to seal the opening. In one embodiment, the combination of the can and the installed cap serve as the only hermetic casing or packaging needed for the battery core that is contained therein. At least some of the non-conductive paths are formed in the cap. The cap may be predominantly made of a moisture impermeable and electrically insulating material, such as ceramic, e.g. alumina and zirconium-based ceramics, in which the conductive paths can be formed. The pair of external battery terminals may also be exposed in an outer surface of the cap.

In one embodiment, each of the conductive paths formed in the cap provides a separate current path between a respective one of the cell subsets inside the can and an outer portion that is exposed outside of the can. Part or all of the management circuit in that case may be installed on an outside surface of the cap while connected to the outer portions of the conductive paths. Alternatively, part or all of the management circuit may be imbedded within the conductive cap (while the management is also coupled to the pair of external terminals that provide the primary output voltage).

In another embodiment, part or all of the management circuit may be located inside the hermetically sealed casing, between the cell core and the cap. In that version, some of the connections between the cell subsets and the management circuit may not be formed within the cap but rather through for example a flex circuit that is inside of the casing.

The cap may be bonded to the can using for example organic epoxy or glue to seal off the gap in the can opening, between the cap and the can, along the entire edge of the cap. In another embodiment, the cap has a metallization formed along its edge or periphery (e.g., the entire edge), and the cap in that case may be bonded to the can by a metal-to-metal bond between the cap metallization and the edges of the can walls, e.g. solder, braze, weld.

In one embodiment, the can is a pre-formed metallic, rectangular prism or polyhedron having six faces. The can has a single face that is unformed, thereby defining a single opening through which a battery core structure can be inserted into the can. The can may have a high aspect ratio, and the opening may be an entire side of the can. Other ways of structuring the can are described. For instance, the single opening of the can may be the entirety of a top face (rather than a side), so that the can roughly resembles a tub. The battery core in that case is inserted into the tub from the open top. To seal off such a can, a four-sided metal piece may be created and bonded along three of its sides to the can opening boundary. The cap is positioned next to the top metal piece and may be bonded along one of its edges to the free edge of the top piece, and along three others to the can opening boundary. The tub may be shaped other than a rectangular prism, such as oval, triangular, pentagonal, hexagonal, and irregular. In such cases the cap would be oval, three-sided, five-sided, six-sided, and irregular-sided to fit the tub's top opening. An electroforming process can be used to make the various embodiments of the can, which may yield relatively thin can walls. However, a lower cost conventional metal drawing process may also be used, particularly in this case of the tub-like can and the top piece.

In another aspect, the can may be four-sided (four joined faces) and its opening is sealed by a two-sided (two joined faces or L-shaped) cap. In yet another embodiment, the can may only be three-sided (three joined faces) and the cap is three-sided as well. Bringing those two together will create a six-sided prism again. Such techniques may make it easier to insert or position the core into the can. In yet another embodiment the can may be a tub body (any of the shapes listed above) wherein not only the topside or face is missing but also one of the sidewalls. Once again, in this case, an appropriately shaped cap is joined to the tub body (and sealed along the gaps between the cap and tub body) forming a hermetically sealed casing in which the battery core is located.

In yet another embodiment, the can is formed as a frame in which for example four side faces are joined leaving open top and bottom faces, so that the can is sealed with two separate cap pieces, namely a top piece and a bottom piece, one or both of which may be made of predominantly non-conductive material and one or both of which may have conductive paths formed therein in order to connect with the cell subsets inside the can.

The cap may contain the primary (+) and (−) external battery terminals, and/or it may contain a number of conductive paths that are connected to the individual cell subsets that constitute the cell core, thereby enabling connections to the management circuitry to individually address each cell subset for monitoring purposes and/or to make parallel or series connections amongst the cell subsets. In addition to a plate portion, the cap may also have an integrally formed platform or tongue that may extend outward (e.g., substantially perpendicular to the plate). This platform may contain features such as a mechanical attachment mechanism (e.g., threaded screw holes, interlock, snap-fit or elastic interlock) that may be used to install the finished battery into for instance a consumer electronics device.

In another aspect, the battery core is processed so as to create an integrated or “in-situ formed” casing all around it. The core is electrically insulated, by being coated with a dielectric layer, for example, a Parylene coating, and then a moisture barrier layer is metalized directly onto the Parylene-covered core. In this case, the metallization could overlap the end cap material (e.g., ceramic). As an alternative, the cap may be omitted, for example, if the external battery terminals or connectors can be joined to the cell terminals of the core and electrically insulated (to avoid electrical shorts when applying the moisture barrier metallization).

In another aspect, various techniques for making electrical connections between cathode or anode layers of a thin film battery rectangular prism core stack are described that may assist in achieving tight tolerance on the dimensions of the battery core stack, so that the core stack can be more easily inserted into the can.

A further aspect of the invention is a technique useful for mitigation of substrate curvature of a thin film battery core stack, which again helps meet tight tolerance levels on the dimensions of the stack.

The above summary does not include an exhaustive list of all aspects of the present invention. It is contemplated that the invention includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

The embodiments of the invention are illustrated by way of example and not by way of limitation in the figures of the accompanying drawings in which like references indicate similar elements. It should be noted that references to “an” or “one” embodiment of the invention in this disclosure are not necessarily to the same embodiment, and they mean at least one. Also, a given figure may be used here to illustrate the features of more than one embodiment of the invention, and not all elements in the figure may be required for a given embodiment.

FIG. 1 is a perspective view of an example can and cap, and a battery core that is to be inserted into the can through a can opening.

FIG. 2 is a perspective view of the battery of FIG. 1 with the battery core fully inserted into the can and the cap having sealed the can opening.

FIGS. 3A, 3B are perspective and section views of a tub-like can.

FIG. 4 is a perspective view of another can and cap combination.

FIGS. 5A, 5B show in perspective how an example battery core may be electrically connected to conductive paths in the cap that provide a primary output voltage of the battery through a pair of external terminals, and how the cap may seal the can opening.

FIG. 5C is a section view of the cap as installed into the opening of a can, in accordance with several embodiments of the invention.

FIG. 5D is a section view of a cap with references to a multi-shot injection molding process.

FIG. 6 is a section view of a cap as installed into the opening of a can, wherein the cap has multiple conductive paths therein that are connected to multiple battery cell subsets, and to which a battery management circuit is also connected.

FIGS. 7A, 7B show perspective views of how corner connections can be made between electrochemically active (electrode or pole) layers of a battery core stack.

FIG. 7C shows another way to make connections between electrode layers of a battery core stack, using a “dog ear” approach.

FIG. 7D shows yet another way to make connections between electrode layers of a battery core stack, using a conductive post-type structure and adhesive approach.

FIG. 7E shows yet another way to make connections between electrode layers of a battery core stack, namely a wire bond-through-notch approach.

FIG. 7F shows yet another way to make connections between electrode layers of a battery core stack, namely using wire bonds that are joined at the faces of the electrode layers, and a flex circuit or other printed circuit board.

FIG. 7G shows yet another way to make connections between electrode layers of a battery core stack, namely using wire bonds that are joined at the edges of the electrode layers, and a flex circuit.

FIG. 7H shows how the wire bonds that connect the electrode layers to a flex circuit can be positioned at the corners of the battery core stack to take advantage of open corner spaces inside the can.

FIG. 7I shows yet another way to make connections between electrode layers of a battery core stack and a flex circuit, using folded tab extensions of the electrode layers.

FIG. 7J shows yet another way to make connections between electrode layers of a battery core stack and a flex circuit, using vertical connections that are made through aligned tabs of the electrode layers.

FIG. 7K shows yet another way to make connections between electrode layers of a battery core stack and a flex circuit to (reach the conductive paths in the cap), using an “interleaf” approach where the flex circuit is wrapped around three sides of each cell subset stack.

FIG. 7L shows how the cap may have a board to board connector installed on its inside face to gather the connections from the electrode layers, through a connected flex circuit.

FIG. 8 is a section view of a battery core having an integrated or in-situ formed metal casing thereon.

FIG. 9A illustrates the use of a balancing film on a backside of a substrate of a thin film battery core stack, to help mitigate substrate curvature during formation of a cathode on the opposite side of the substrate.

FIGS. 9B, 9C, 9D illustrate different processes for making part of a thin film battery core stack having a backside stress balancing film.

### DETAILED DESCRIPTION

Several embodiments of the invention with reference to the appended drawings are now explained. Whenever the shapes, relative positions and other aspects of the parts described in the embodiments are not clearly defined, the scope of the invention is not limited only to the parts shown, which are meant merely for the purpose of illustration. Also, while numerous details are set forth, it is understood that some embodiments of the invention may be practiced without these details. In other instances, well-known circuits, structures, and techniques have not been shown in detail so as not to obscure the understanding of this description.

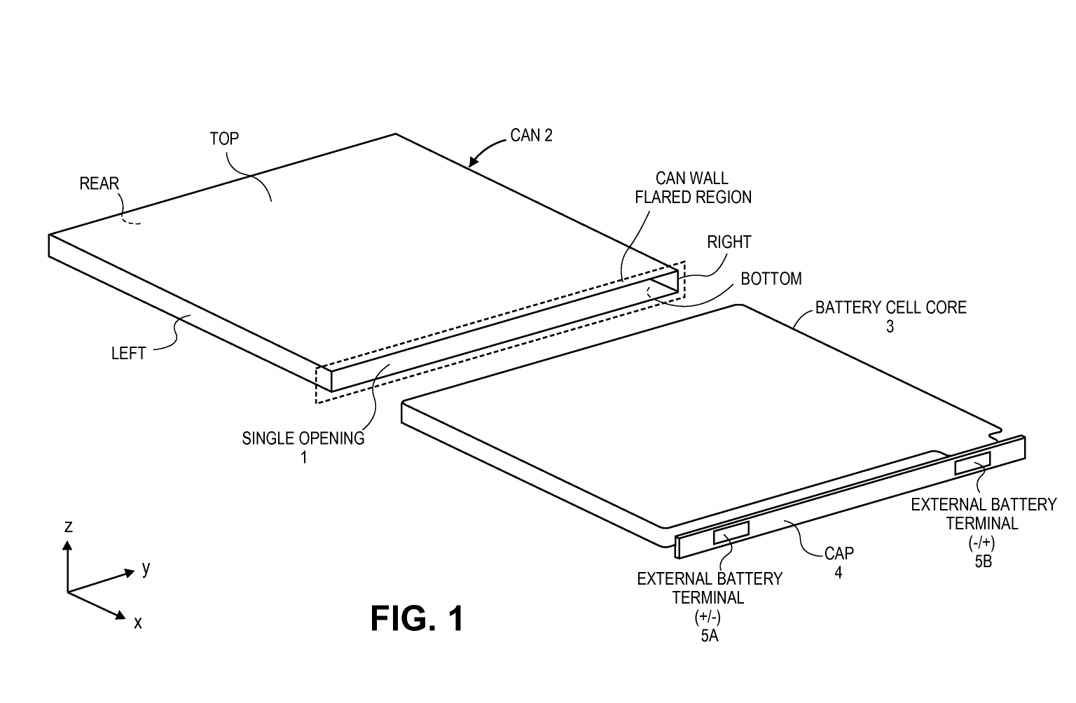

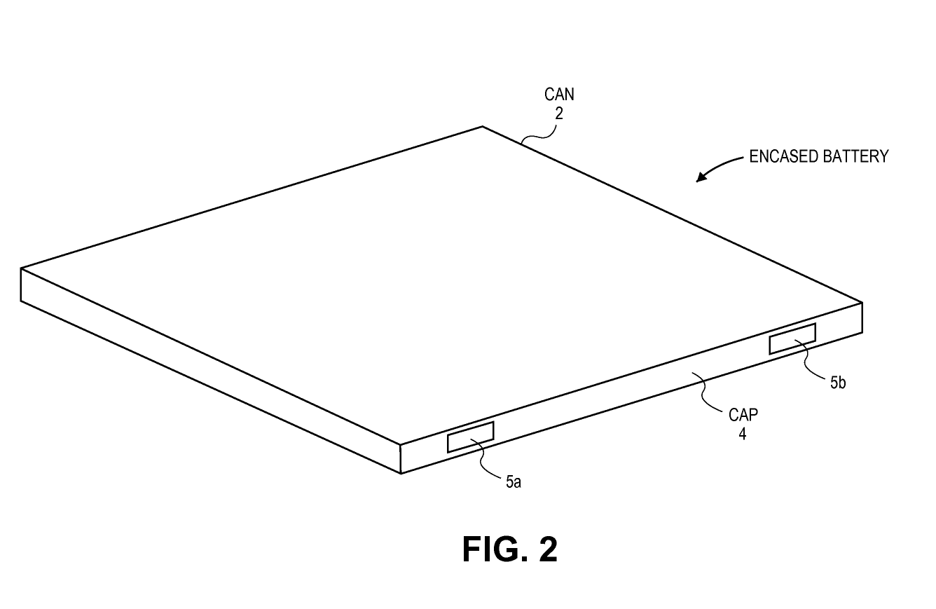

FIGS. 1 and 2 depict perspective views of an illustrative example of a hermetically sealed battery as described here. These figures depict how a hermetically sealed casing can be provided for a battery core or battery core assembly, which may be a thin film battery stack, using a pre-formed metal or metallic can. Specifically, FIG. 1 is an exploded perspective view of the battery, which may comprise a can 2, a cap 4, and a battery core 3 that is to be inserted into the can 2 through a can opening. FIG. 2 is a perspective view of the battery of FIG. 1 as assembled. As shown there, the battery core may be positioned within the can 2, and the cap 4 may be sealed to the can to cover the can opening. Together, the can 2 and cap 4 may form a hermetically sealed housing in which the battery core 3 may be held.

The casing formed by the can 2 and the cap 4 may have any suitable geometric shape. In some variations, the casing may be a prism having a base shape. For example, in the variation shown in FIGS. 1 and 2, the base shape is rectangular, such that the casing is a rectangular prism. In other variations, the base shape may be a triangle, a circle or oval, c-shape, other polygon, irregular shape, or the like. When the casing has a prism shape, the can may also have a prism shape with one or more openings. For example, the can in FIGS. 1 and 2 has a rectangular prism shape, although it could have other shapes such as those listed above. In the example shown, the can has a single opening 1 through which the battery core 3 (also referred to as a cell core or a thin film cell stack) can be inserted. The polyhedron or cuboid shape of the can has six faces as shown, namely a top, an oppositely positioned bottom, a left side, a right side, a rear side, and a front side in which the single opening is formed. In other words, there are five “formed” faces, and the sixth face, which in this case is the front side or front, is open or “unformed”. While the opening 1 is shown in FIGS. 1 and 2 as being formed in a front side face, it should be appreciated that the opening may be formed in any of the faces. Generally, the cap 4 is sized to plug or otherwise cover the entirety of the opening 1 to provide a complete enclosure. In the example shown in FIGS. 1 and 2, the can opening 1 is the entire face of the prism and once appropriately sized the cap 4 by itself can be fitted to plug the entire can opening 1, after the core 3 has been inserted. FIG. 2 shows the encased core 3, where the core 3 has been inserted fully into the can 2 and the opening 1 has been entirely covered by the cap 4.

An example technique for making the can 2 is to use electroforming, which may involve machining a mandrel and then plating or depositing metal, e.g. copper, nickel, aluminum, onto the mandrel and then removing the mandrel. Electroforming can yield sharp edges inside the can 2, which means high utilization of the inner volume of the can by the battery core 3 which in turn leads to higher packaging efficiency and greater energy density for the finished battery. In addition, the process can yield a very thin can wall, e.g. on the order of a few tens of microns, which is an advantage for fitting the finished battery into a space constrained device (such as a personal portable consumer electronic device). The electroforming process can be performed so that there is zero draft or taper on the mandrel to yield a right angle along each edge of the can. In most instances, the outside thickness or height of the can may be less than 5 millimeters. Just as an example and not to limit the scope of the invention, the outside dimensions of the can may be on the order of 40×40×2 millimeters, and the battery stack, of course, will have similar dimensions, smaller by at least the can material thickness and cap material thickness.

The battery core 3 may be a thin film lithium-based battery core stack, or it may be a battery core whose constituent cells have another type of electrochemistry. In many instances, the core 3 is composed of layers of electrochemically active material, referred to as cell electrodes. These may form one or more cells, where each cell is made up of at least one cathode electrode and at least one anode electrode, where the two are referred to as “complementary poles”, and a separator to separate the two poles. The cathode and anode may be referred to as pole layers, and the separator may be provided as a separate layer, together as a stack. Note that the term “layer” here is used generically, in that a layer may be formed as a laminate of one or more sub-layers of the same or different materials. For example, a cathode layer may include an active cathode material positioned on or otherwise connected to a cathode current collector. Similarly, an anode layer may include an active anode material positioned on or otherwise connected to an anode current collector. There may be several cells that are electrically connected to each other to form the battery core 3. Two or more cells may be connected in parallel or in series to each other, to form a cell group. There may be one or more cell groups that make up the battery core 3. Various techniques for connecting cells to each other and to the cap 4 are described below.

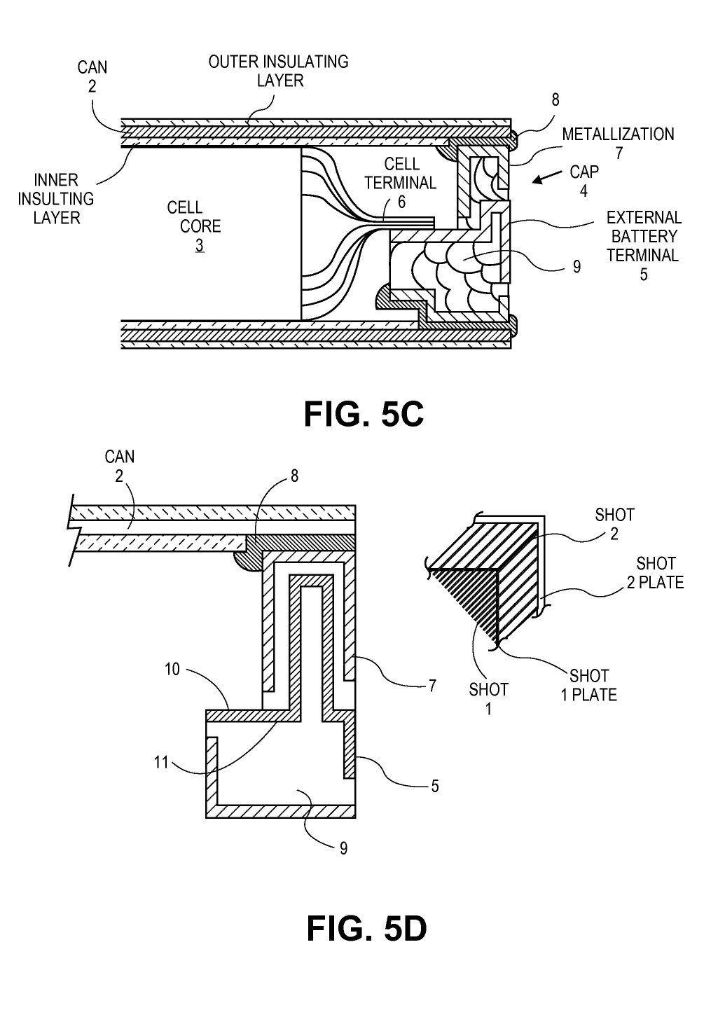

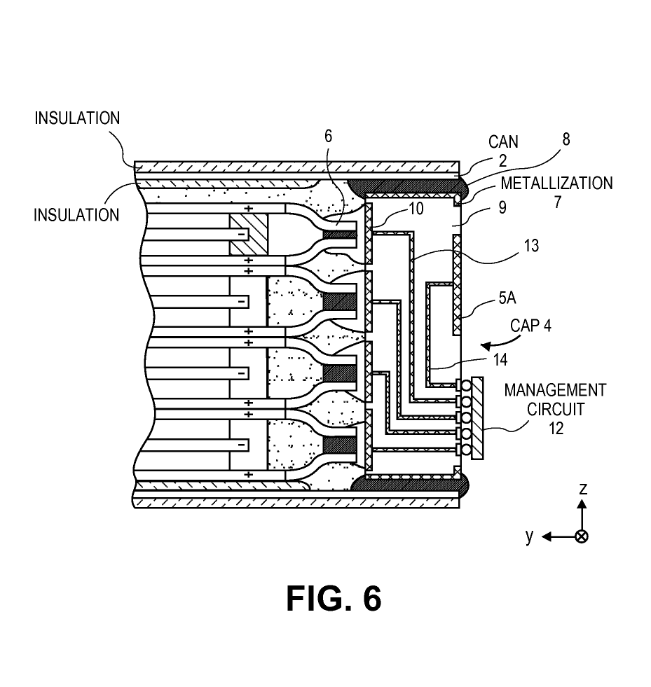

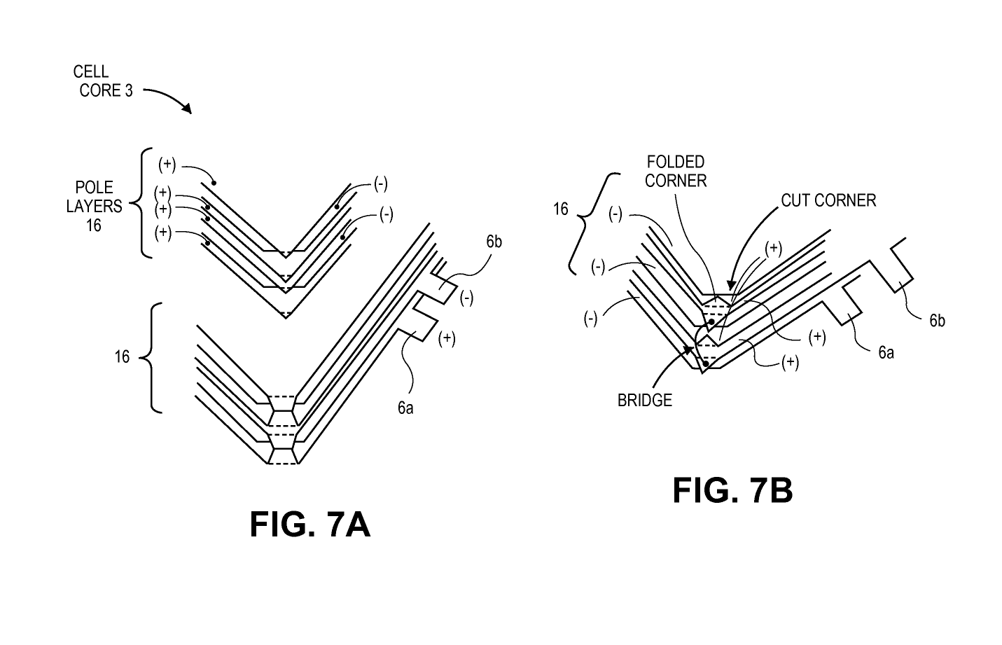

The battery core 3 may be electrically insulated on its outside surface through application of one or more layers of electrically insulating materials (e.g., by dipping into solutions of insulation materials or by vapor deposition), prior to being inserted into the can 2 (whose inner surfaces may be exposed metal). This helps avoid creating a short circuit between the complementary pole electrodes of the battery cell core. In another embodiment, the inside surface of the can 2 may be insulated by applying one or more electrically insulating coatings, which may avoid the need to also electrically insulate the outside surface of the battery core prior to insertion (although it should be appreciated that both an outside surface of the battery core 3 and the inside surface of the can 2 may be insulated). To help ease insertion, a very thin layer of solid lubricant may be added to the inside surface of the can 2 or to the outside of the battery core. Also, the exterior of the can could also be covered with an electrically insulating layer such as a dielectric coating. See, e.g. FIG. 5C described below.

In some instances, such as seen in FIGS. 1-2, the can 2 may have a high aspect ratio, namely that it is quite deep (in the x-dimension) and thin (in the z-dimension), i.e. the x-dimension and the y-dimension are each ten times greater than the z-dimension. The core 3 and can 2 may be dimensioned so that the core can be inserted into the can through the opening leaving only a very small gap between the inside surface of the can and the top, bottom, and left and right sides of the core. This gap may allow the battery core 3 to slide into or otherwise be positioned in the can 2 but with very little side-to-side play. At the rear of the can, the battery core 3 may abut the inside surface of the rear face of the can. While the battery core is in its charged state, the shape of the stack may be identical to the shape of the can, so that there is very little space between the outside surface of the core and the inside surface of the can. This type of dimensioning of the enclosure (e.g., can 2 and cap 4) to very closely match the battery cell core dimensions helps reduce wasted volume inside the can, thereby helping improve energy density of the battery, by allowing the battery core to be made as large as possible (yet still capable of being inserted into a can of a given size). In some instances, it should be appreciated that one or more gaps may be present between the battery core 3 and one or more internal surfaces of the casing, which may be present to allow for one or more cell terminal tabs, flex circuit components, or the like to be positioned in the casing. For example, the battery may include a larger “front side” gap between the cap 4 and the front of the core 3, which may in turn allow the electrodes of the core 3, to form or otherwise be connected to cell terminal tabs or extensions and make electrical connections with respective conductive paths in the cap 4 that lead to the (+) and (−) external battery terminals 5a, 5b, such as discussed in more detail below.

In another embodiment of the invention, referring back to FIG. 1, a flared opening may be provided as part of the walls of the can 2, so as to allow the “funneling” or easier insertion of the battery core. The flared region may be integrally formed in an electroforming process for example, and extends outward from the opening as shown. Once the battery core has been inserted into the opening, the flared region can be removed by cutting it off, using a laser or knife for instance. The flared region may be removed once the cap 4 has been sealed to the can 2, or it may be removed before sealing the cap 4 to the can 2.

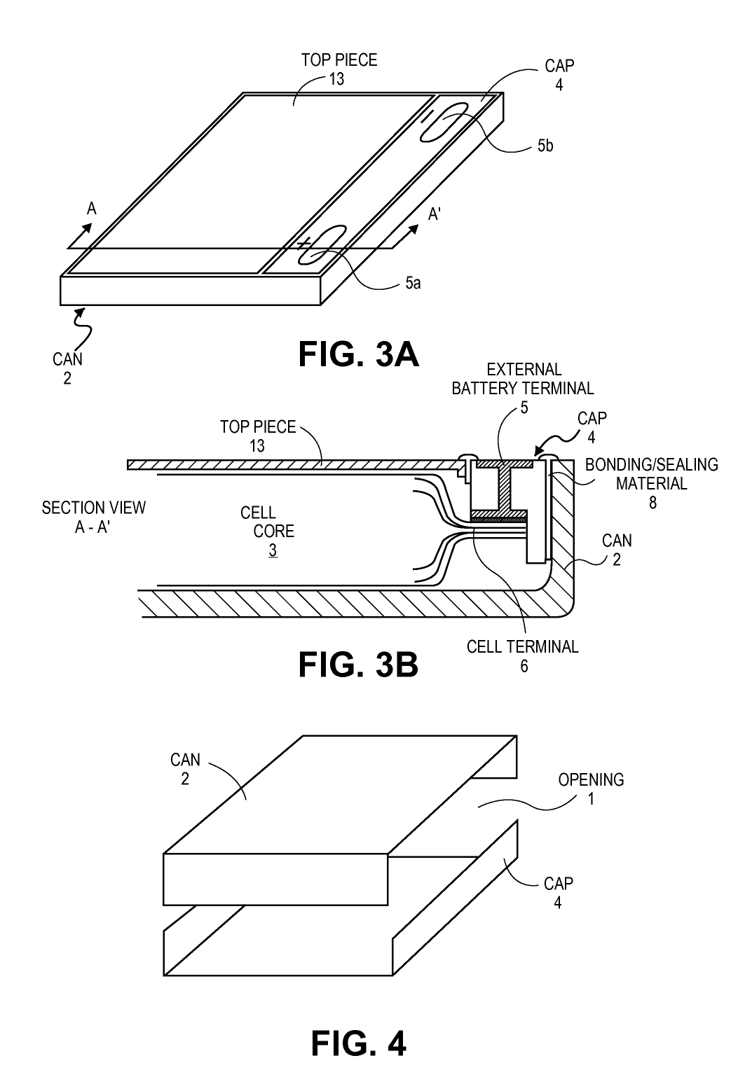

In some instances, the battery casing may be formed from two pieces (a can and a cap as introduced above), but it should be appreciated that in other instances the battery casing may be assembled from any suitable number of separate pieces. For example, the can 2 shown in FIGS. 1 and 2 may be formed from multiple separate pieces that are connected to form the can 2. Turning now to FIGS. 3A, 3B, another such embodiment of a battery is shown. As shown there, the battery casing may comprise a can 2, a top piece 13, and a cap 4. The can 2 may be an electroformed metal can as discussed above, but need not be. In other instances, the can 2 may be drawn or short drawn, into roughly the shape of a tub. Here, the top face is open, rather than a side face as in the embodiment of FIG. 1 (but may still retain a high aspect ratio). A separate top piece 13 (which in some variations may be made predominantly of metal) may be formed and joined to the walls of the can 2, such that top piece 13 partially fills or covers the opening 1 of the can 2. The cap 4 may fill the remaining portion of the opening 1 of the can 2. Accordingly, the top piece 13 and cap 4 may be dimensioned to fit together with the cap 4 to completely plug or completely fill the open top face of the can 2 as shown. In contrast to the embodiment of FIGS. 1-2, where the cell stack is inserted through a “smaller” side opening, here the cell stack may be inserted through the larger top face opening 1 of the can 2 to position the battery core 3 within the battery casing.

The pieces of the battery casing may be assembled in any order. In some variations, the cap 4 and top piece 13 may be connected together prior to being connected to the can 2. In other variations, the top piece 13 may be connected to the can 2 prior to connecting the cap 4, or the cap 4 may be connected to the can 2 prior to connecting the top piece 13. In still other variations, the pieces may be connected simultaneously.

Again, the battery housing or casing shown in FIGS. 3A and 3B need not form a rectangular prism but could alternatively form other shapes, including prism shapes such as a circular prism (like a hockey puck), triangular prism, oval prism, pentagonal prism, hexagonal prism, irregular prism, etc., such as discussed above. When a cap 4 (or a cap 4 and a top piece 13) cover an open top surface of a prism, the cap 4 (or cap 4 with top piece 13) may have a shape corresponding to the base shape of the prism. In such cases the cap could be circular, triangular, oval, five-sided, six-sided, irregular-sided, etc. to fit the tub's top opening. In yet another embodiment the can may be a tub body (having any of the shapes listed above) wherein not only the top face is missing but one of the sides or walls is also missing. Once again, in this case, an appropriately shaped (substantially L-shaped) cap is formed that can be joined to the tub body (and sealed along the gaps between the cap and tub body) forming a hermetically sealed casing in which the battery core is located.

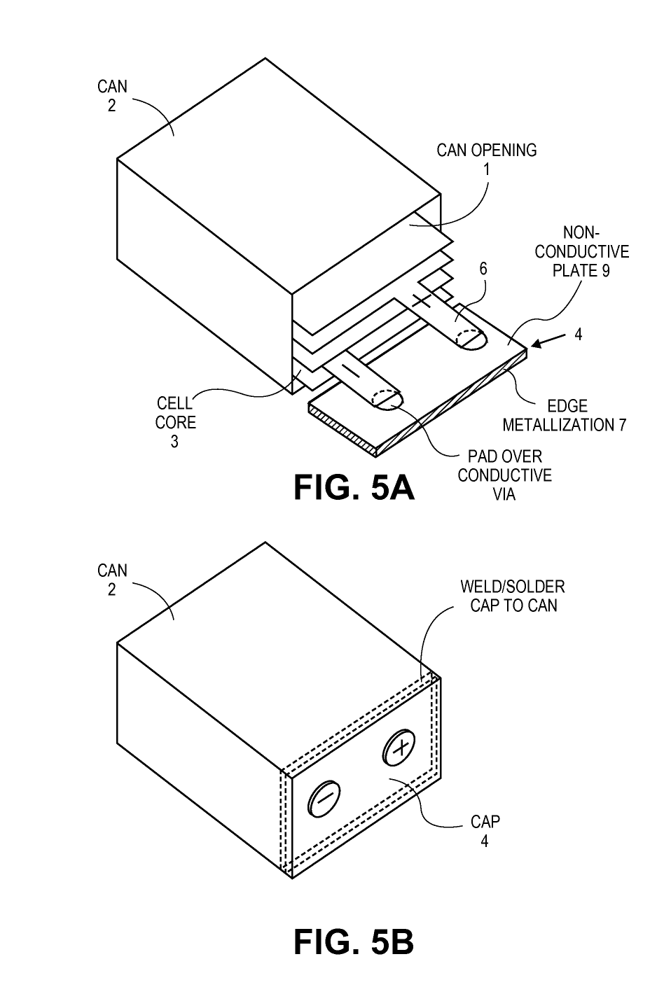

In another aspect of the invention, the can's rectangular prism can be four-sided (four joined faces) and is sealed by a substantially L-shaped cap, i.e. two-sided or two joined faces. In yet another embodiment, depicted in FIG. 4, the rectangular can is three-sided (three joined faces) and the cap is three-sided as well. In each of those cases, bringing the two separate pieces together will create a six-sided prism again.

In yet another embodiment (not shown), the can is formed like a frame (e.g., circular, oval, triangular, rectangular, hexagonal, etc.) having a curved sidewall only, or a multi-faceted side wall only, leaving open top and bottom faces. In that case, the can is sealed (and a complete prism is formed) when two separate cap pieces, namely a top face piece and a bottom face piece, are joined to the frame.

Turning now to the cap 4, also referred to as an end-cap, in one embodiment this may be comprised of a plate made of a moisture impermeable and electrically insulating material, such as ceramic or plastic, that supports one or more conductive paths (e.g., vias) therein, for example similar to a printed circuit board. In one embodiment, the plate comprises at least two conductive paths which are connected to the battery core to provide a primary output voltage at external terminals 5a, 5b—see FIG. 2. Each conductive path has an inner portion that is exposed inside the can 2 and that can be used to make an electrical connection with a respective cell electrode of the battery core 3. These conductive paths have ends that are exposed outside of the cap 4 that form the external battery terminals 5a, 5b.

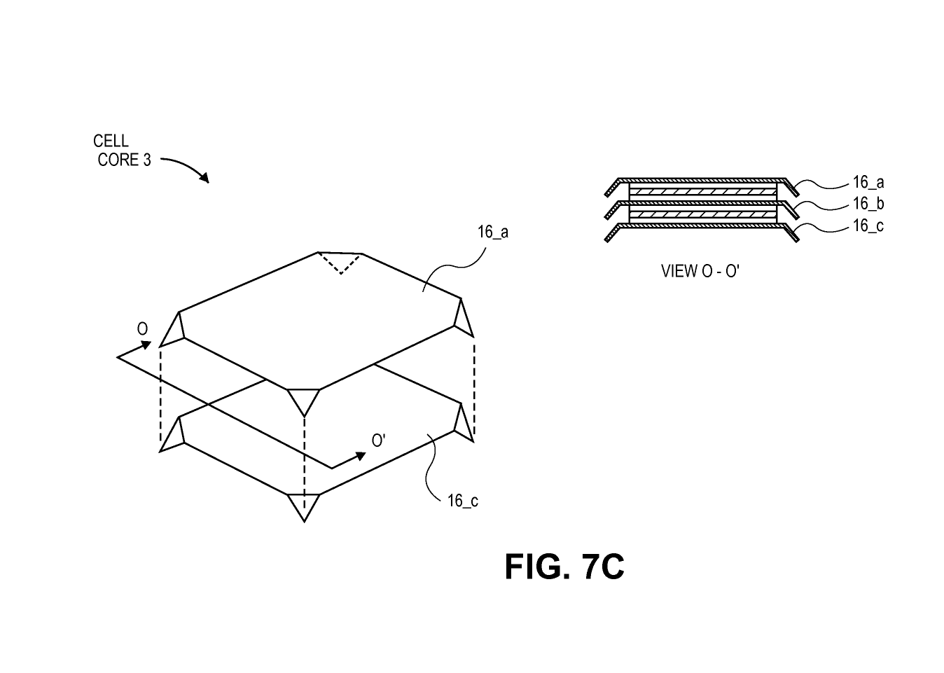

In another embodiment, the cap 4 has further conductive paths that are embedded or otherwise integrated within the plate to allow each cell or cell group of the core 3 to be individually addressed by, for example, a battery management circuit 12 (which can be located externally of the battery casing as in FIG. 6, or partially or wholly embedded in the battery casing, or partially or wholly inside the battery casing between the cell core 3 and a casing wall). Various techniques for forming the cap 4 and its embedded conductive paths, and for electrically connecting the cell electrodes to those conductive paths, are described below.

With the core 3 in place inside the can 2, and the cap 4 covering the can opening (so as to only leave a very small gap along its periphery) while the external battery terminals 5a, 5b are connected with their respective cells or cell groups (e.g., through one or more cell terminals 6 as shown in FIG. 3B), the gap between the can 2 and the cap 4 is sealed by, for example, applying an epoxy or glue along the gap (at the edge of the can opening).

Another technique for sealing the can opening 1 using a cap 4 is now described which may provide for a moisture and oxygen impermeable battery casing. In this embodiment, a metallization 7 being of a non-organic material has been formed along the entire edge or periphery of the cap 4—see FIG. 5A. This allows the edge of the cap 4 to then be bonded (e.g., soldered, brazed, welded) directly to the exposed metal edges of the walls of the can 2, thereby sealing the can opening as seen in FIG. 5B. In one embodiment, a low flux or flux free solder is used to form the bond. Accordingly, in some variations of the battery casings described here, the battery casing may comprise a can 2 and a cap 4, where the cap 4 comprises a plate formed from a moisture impermeable and electrically insulating material (e.g., a ceramic or other material as discussed above), the plate having a metallization 7 around an edge or periphery thereof. The resulting battery casing may include the cap 4 bonded to the can 2 via the metallization 7 to hermetically seal the battery casing. The plate may further comprise one or more conductive paths extending there through, such as discussed herein throughout.

As seen in FIG. 5A, in one embodiment, the battery core 3 may have an extension area or tongue in, or attached to, one or more of its constituent electrode layers in the x-y plane, wherein the extension areas may comprise metallic traces or electrical connection tabs (generically referred to here as cell terminals 6) for connection to the cap 4. This may also be true of the embodiment shown in FIG. 3B where a stack of such tabs may be connected to each other to form a cell terminal 6. These tabs or cell terminals 6 make electrical connections with exposed portions of the conductive paths (e.g., pads over conductive vias) that are formed in or embedded within the cap 4 and that are exposed inside the casing. The electrical connections may be conductive glued, welded, soldered, or they may be maintained by forced contact between the cell terminal 6 and the exposed metal of the conductive path on the inside surface of the cap 4.

As discussed above, and still referring to FIGS. 5A, 5B, the cap 4 is formed of a non-conductive material, e.g. a ceramic, e.g. alumina, generically referred to here as a plate 9 (which need not be entirely flat—see e.g., the embodiments shown in FIG. 3B, FIG. 5C and FIG. 5D where the plate 9 may also have a shelf type structure formed on its inside face). The plate 9 may be metalized around its periphery (edge metallization 7). Note that in most instances, the metallization 7 is electrically insulated from all of the conductive paths in the cap 4 (that will be used to connect to the cell electrodes for either providing the primary output voltage or for connections to the battery management circuit). In one case, the conductive paths in the non-conductive plate are pads over conductive vias (where the pads can be soldered to for example), where some of the vias extend through the plate to reach the external battery terminal structures 5a, 5b (see also FIGS. 1-2). Other types of conductive paths may be formed in the plate 9, such as discussed below.

Still referring to FIG. 5A, on the inside surface of the plate 9 as shown, in one embodiment, the pads may first be soldered or otherwise welded to their respective cell terminals 6, and then the so-attached plate 9 is rotated which bends the cell terminals 6 towards the opening of the can 2 (into which the cell core 3 has been partially inserted). The core 3 is then inserted fully into the can 2, arriving at the arrangement shown in FIG. 5B in which the cap 4 completely fills or plugs the opening. The metallization 7 at the edge of the cap 4 is then used to seal the can 2 by welding or soldering or brazing the edge metallization 7 to exposed metal of the edges of the walls of the can 2.

As mentioned above, the cap 4 may be made of a plate or board that is made of a ceramic or other suitable non-conductive material, and has a number of feed-through conductive paths built in (some of which form parts of or extensions of the external battery terminals 5a, 5b). In one embodiment, the cap 4 including the integrated electrical interconnect therein may be made using a low temperature co-fired ceramic (LTCC) electronics packaging fabrication technique, in order to form the conductive paths or traces therein. The plate or board in that case may be an alumina sheet that has a laser drilled conductive via formed therein, e.g. for each of the external battery terminals 5. A further metallization layer (not shown) can be formed across the face of the plate, to help improve liquid and gas impermeability while keeping the overall dimensions of the cap 4 very small, so as to leave the least amount of ceramic or alumina exposed to the atmosphere. See also FIG. 5D where the metallization 7 (at the edge or periphery of the plate 9) wraps around and extends across the front and rear faces of the plate 9 as much as possible, like a partial sleeve that does not touch any of the conductive portions 5, 10, 11.

As mentioned above, some of the conductive paths may electrically connect an electrode or electrode group of the battery core 3 to an external battery terminal 5 of the battery casing. In some variations, such as shown in FIGS. 5C and 5D, such a conductive path of the cap 4 may directly connect the electrode or electrode group to the external battery terminal 5. For example, as shown there, a conductive path of the cap 4 may be composed of an inside portion 10, a bridge portion 11, and an outside portion also referred to as the external terminal 5. In other variations, such as described in more detail with respect to FIG. 6, a first conductive path 13 of the cap 4 may connect an electrode or electrode group of a battery core 3 (through a cell terminal 6 for example) to a management circuit 12 (such as a battery cell monitoring or control circuit), and a second conductive path 14 may connect the management circuit 12 to the external terminal 5a. Note in that case the second conductive path 14 need not have any inside portion that is exposed inside the casing. Although not shown in FIG. 6, there may be a further conductive path inside the cap 4 that serves to directly connect another external terminal 5b to another other electrode or electrode group (e.g., a (−) electrode or (−) electrode group) of the battery core 3.

In some instances, the cap 4 may be fabricated like a printed circuit board or printed wiring board. Just as an example, an alumina sheet of about 250 microns thick can be provided with solderable pads formed on the inside face that align with the cell terminals 6, as seen in FIG. 5A. The cell terminals 6, which may be tabs or extensions of electrode layers emerging from the side of the battery core 3, are then bonded to the inside portions of respective conductive paths (e.g., through vias connected to in pads formed in the cap 4), respectively, and then the cap 4 is rotated upward and fitted into the can opening to result in the configuration shown in FIG. 5B, covering the opening of the can 2 so that the edge metallization at the periphery of the cap can then be bonded to the edge or boundary of the can wall. Pads may also be formed as the external terminals 5 on the outside surface of the non-conductive plate 9 of the cap 4, which are electrically connected by the through vias to the inside pads, thereby completing the external battery terminal structure.

Turning now to FIG. 5C, this is a section view of the cap 4 as installed into the opening of the can 2, in accordance with several embodiments of the invention. In this example, the cell terminals 6 of the core 3 may remain horizontal while they are joined with the horizontally oriented inside portions 10 of the conductive paths of the cap 4 (a similar horizontal orientation appears in the embodiment FIG. 3B). Contrast this with the approach used in FIG. 5A where the cell terminals 6 are bent at about a right angle while they are in contact with the inside pads of the cap 4. Some of the conductive paths in the cap 4 may extend into outside portions (e.g., external battery terminals 5), which are exposed on the outside of the battery (although it should be appreciated that other conductive paths, such as those described above, may remain exposed only on the inside surface of the cap). Note that while the section depicts only one conductive path in the cap 4 leading to the external terminal 5, there are at least two such structures resulting in (+) and (−) primary battery contacts (and there may optionally be more depending on the number of cells or cell groups that are to be addressed individually from outside the can 2). FIG. 5C also shows the optional outer and inner insulating layers of the can 2 that may cover the entire outside and inside surfaces of the can 2. The cap 4 is hermetically sealed to the can walls along the metallization 7, which may leave a sealing/bonding material 8 filling the gap, e.g. as a result of solder free or low flux soldering, brazing, or welding, for instance.

The cap 4 may be formed using various techniques mentioned above, including one that is similar to a ceramic printed circuit board fabrication process. In another approach, referring now to FIG. 5D, the cap 4 may be formed by an insert molding process, where injection molding is performed (e.g., by injecting a plastic material) around one or more conductive pieces which may form at least a portion of the conductive paths of the cap. For example, as shown in FIG. 5D, the conductive piece may have an inner portion 10, a bridge portion 11 and an external terminal 5. In other variations, the conductive piece may make up the bridge portion 11, and separate pieces (e.g., conductive pads, board to board connectors) may be connected to the cap 4 and to the bridge portion 11 to form the inner portion 10 and/or the external terminal 5. After the cap 4 has been molded, a metallization may be formed around a periphery of the cap 4 (e.g., by electroforming of the metallization 7 around the periphery of the molded piece). As an alternative, a two-shot injection molding process may be used as depicted in FIG. 5D, wherein the shot 1 plate forms the embedded conductive piece or contact (e.g., the inner portion 10, bridge portion 11 and/or external terminal 5) and the shot 2 plate forms the metallization 7.

In another embodiment, the electronic management circuit 12 used for battery monitoring and/or control can be supported or carried by the finished battery, as follows. Referring now to FIG. 6, the battery core 3 may be composed of multiple cells, which may be divided into a plurality of individually addressable cell subsets (here, four are depicted, where each of the four subsets in this case is a stacklet being a double cell having two physically separated cathodes). Each cell subset may comprise a single cell or multiple grouped cells (e.g., a cell group, such as a double cell), and the battery core 3 may include any suitable combination of cells or cell groups. As mentioned above, in a cell group two or more thin film cells may be mechanically and electrically grouped into a separate “stacklet” that may be electrically insulated from the other cells and/or stacklets through, for example, an electrically insulating intermediate layer (not shown) between adjacent stacklets within the stack. Each cell subset may include a positive terminal conductively connected to the one or more cathode layers of the cell subset and a negative terminal conductively connected to one or more anode layers of the cell subset.

Each cell subset may be individually addressed by the management circuit 12, i.e. by sensing individual cell subset voltage to detect a failing cell subset (and then disconnect the failing cell subset to essentially remove it or prevent it from contributing to the primary battery output voltage) and/or by making series and parallel connections between two or more cell subsets in order to change the primary battery output voltage in response to a request communicated to the battery from an external system. The management circuit 12 may provide one or more of such monitoring and/or control functions, as will be discussed in more detail below. The management circuit 12 may be connected to each cell subset using a group of conductive paths embedded in the casing that are specific to that cell subset. In some instances, each conductive path connects a respective cell subset to the management circuit 12. In these variations, the battery casing may comprise two conductive paths for each cell subset (a first conductive path connecting the positive terminal of the cell subset to the management circuit 12 and a second conductive path connecting the negative terminal of the cell subset to the management circuit 12). For example, if a battery core includes four cell subsets, there may be eight conductive paths connecting the cell subsets to the management circuit, such that each conductive path connects either the negative terminal or positive terminal of a just one cell subset to the management circuit.

In other variations, the battery casing may comprise a conductive path for each cell subset, and may further comprise one or more shared conductive paths where each shared path is connected to multiple cell subsets. In some of these variations, the negative terminal of each cell subset is connected to the management circuit 12 via a conductive path specific to that cell subset and the positive terminals of several cell subsets are connected to the management circuit 12 using one or more shared conductive paths (or vice versa). In one example, a battery core 3 including four cell subsets may have five conductive paths connecting the cell subsets to the management circuits. The first four paths may connect the negative terminals of the four cell subsets, respectively, to the management circuit while the fifth path may be a shared path connecting the positive terminals of all four cell subsets to the management circuit, or vice versa. In other examples, for a battery core 3 that has four cell subsets, six conductive paths are used for connecting the cell subsets to the management circuits. In these instances, the first four paths may connect the negative terminals of the four cell subsets, respectively, to the management circuit while the fifth and/or sixth paths may be shared paths connecting the positive terminals of all four cell subsets to the management circuit (e.g., two cell subsets may be connected to each shared path, or three cell subsets may be connected to one path while the remaining cell subset is connected to the other path, or vice versa).

Referring to FIG. 6, the cap 4 in the above cases may have multiple conductive paths 13 that emerge or are otherwise formed as or are jointed to inner portions 10 (e.g., pads, portions of a board to board connector) on the inside surface of the cap 4, and which may be connected to the battery core 3. The inner portions 10 are in the case of FIG. 6 vertically oriented as shown, but may have other orientations such as horizontal as described above. Each of these inner portions 10 may be joined with, for example, the positive terminal of each cell subset as shown (or in another arrangement, every negative terminal of each cell subset). The physical connections between the terminals 6 of the cell subsets and the inner portions 10 may be made in any suitable manner. In some instances, as shown in FIG. 6, the connection may be made using for example conductive glue or solder that fills the gap between the vertical edge of a tab or cell terminal 6 and the vertically oriented inner portion 10 of a conductive path as shown.

The management circuit 12 is connected to the battery core 3 through conductive paths 13, and may further be connected to external terminals (e.g., terminal 5a as shown in FIG. 6) of the battery casing. A first set of one or more conductive paths 13 in the cap 4 may connect the battery core 3 to the management circuit 12, and a second set of one or more conductive paths 14 may connect the management circuit 12 to the external terminals. The management circuit 12 can monitor the health of the battery core 3, and/or it may perform as a battery gas gauge. Specifically, the management circuit 12 may individually monitor each cell subset, such as the voltage of each cell subset and/or the current being supplied to or drawn from each subset through the conductive paths 13, 14, to detect a failing cell subset (e.g., by comparing the sensed cell subset voltage or current during charge, discharge, or idle conditions to a suitable threshold). The management circuit 12 may then be able to selectively connect and disconnect individual failing cell subsets (e.g., by appropriately closing and opening its solid state current path switches, such as transistors, that are connected to the conductive paths 13, 14) so as to effectively remove or prevent the failing cell subset from contributing to the output power or voltage that can be supplied by the battery through external terminals 5a, 5b of the battery casing. In some instances, the management circuit 12 may be able to configure series and/or parallel connections amongst its available cell subsets (e.g., by appropriately closing and opening its solid state current path switches such as transistors that are connected to the conductive paths 13, 14), which enables the management circuit 12 to change the main or primary output voltage of the battery at the terminals 5a, 5b, in response to receiving a request communicated to the battery from an external system. These functions of the management circuit 12 can yield a fault tolerant battery and/or a smart battery.

In one embodiment, the management circuit 12 may be installed outside of the cap 4 as shown in FIG. 6. In these variations, the conductive paths 13 connected to the cell subsets may extend from an internal surface of the cap 4 to an external surface of the cap 4, and the management circuit 12 may be connected (e.g., via soldering) to the exposed portions of these conductive paths. Similarly, the management circuit 12 may be connected to the external terminals 5a, 5b of the battery casing that are formed as the exposed parts of one or more further conductive paths 14 in the cap 4. Alternatively, some or all of the management circuit 12 may be located inside the can 2, for example in the open space between the rear face of the cap 4 and the front face of the battery core 3. In that case, the connections between the management circuit 12 and the conductive paths of the cap 4 could be through extensions of the inner portions 10. To enable the receipt of the request to change the primary output voltage (communicated from the external system), the casing (and in particular the non-conductive cap 4) may have additional conductive paths formed therein to which the management circuit 12 is connected and through which the management circuit 12 can communicate with the external system. Such communications may also include updates regarding the health of the battery cell core 3, e.g. which or how many cell subsets have failed.

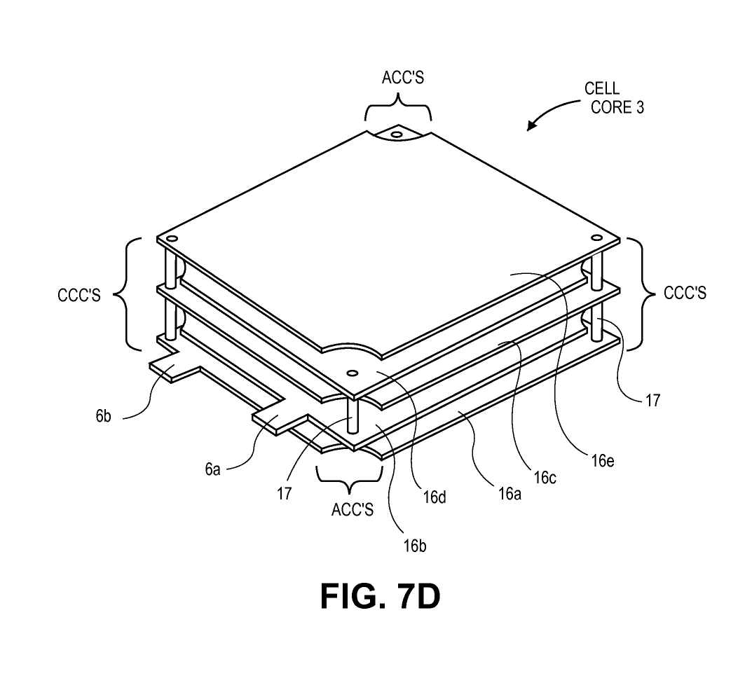

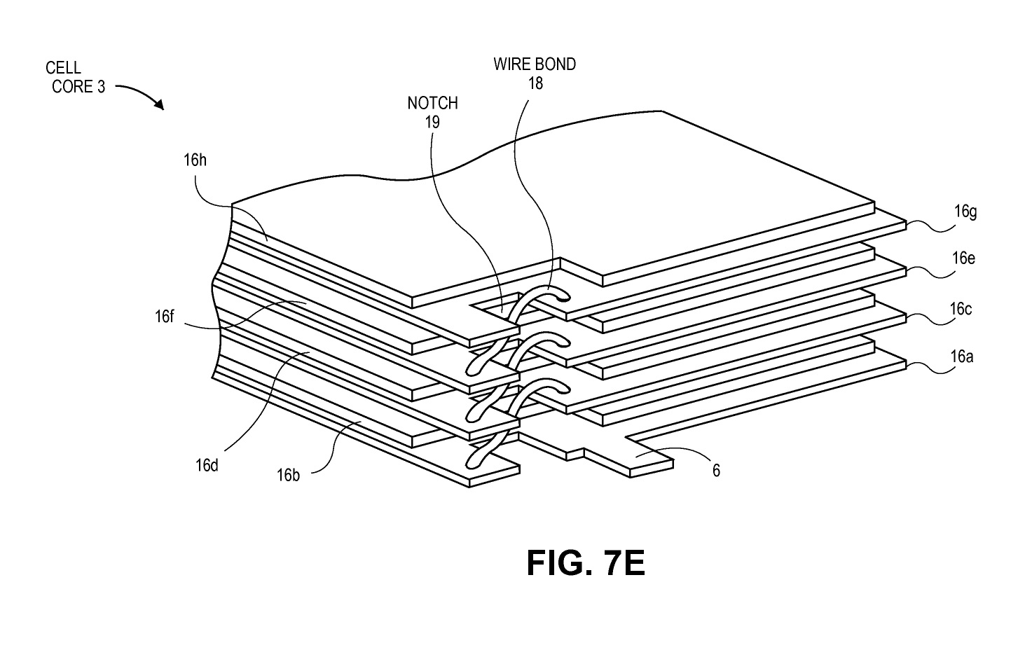

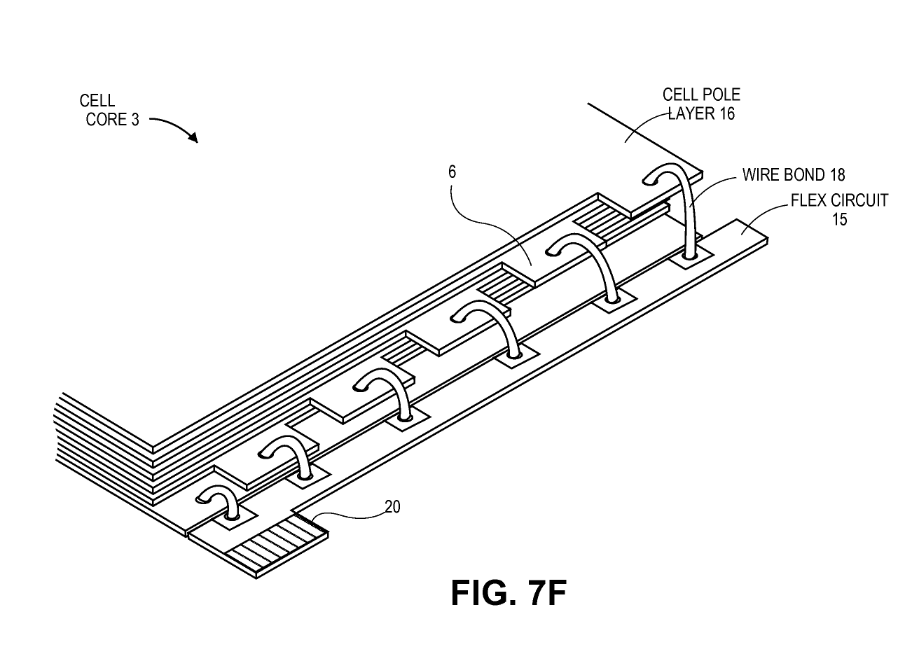

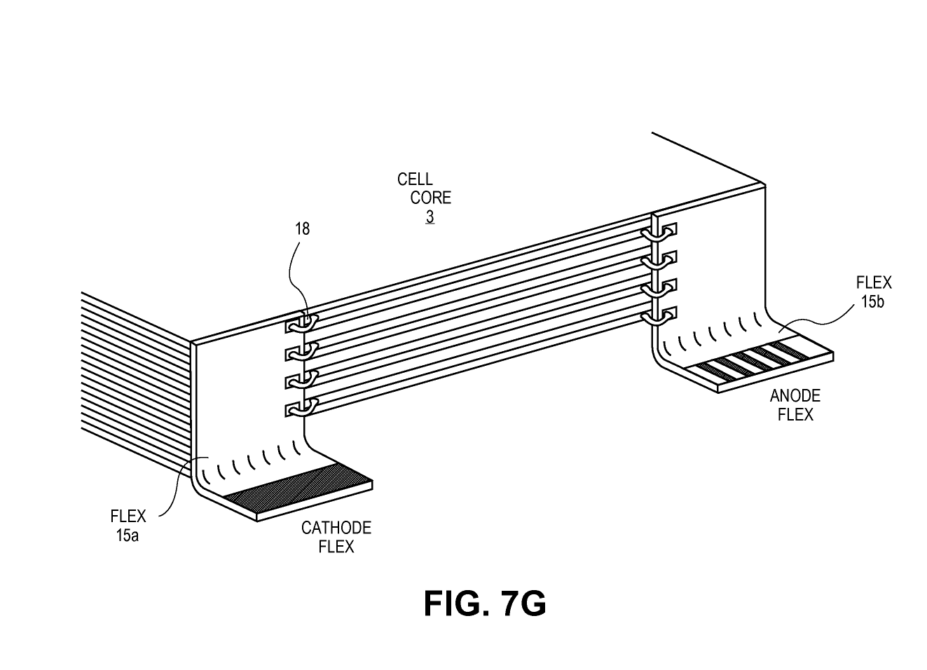

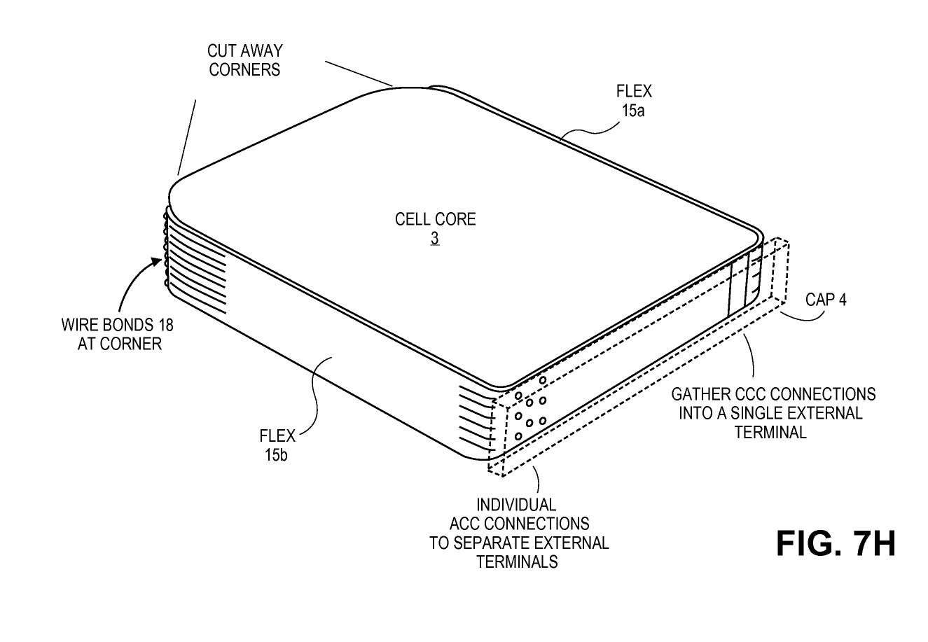

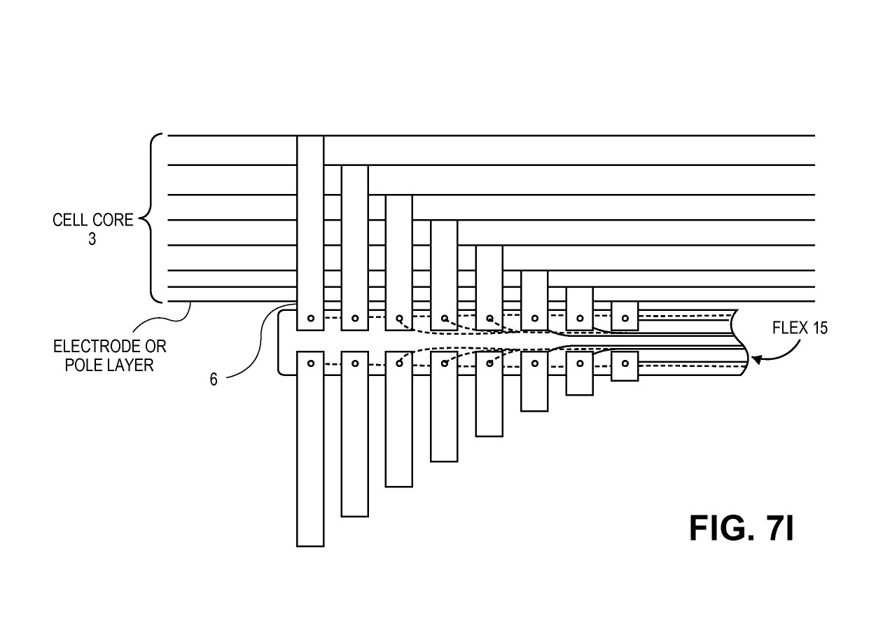

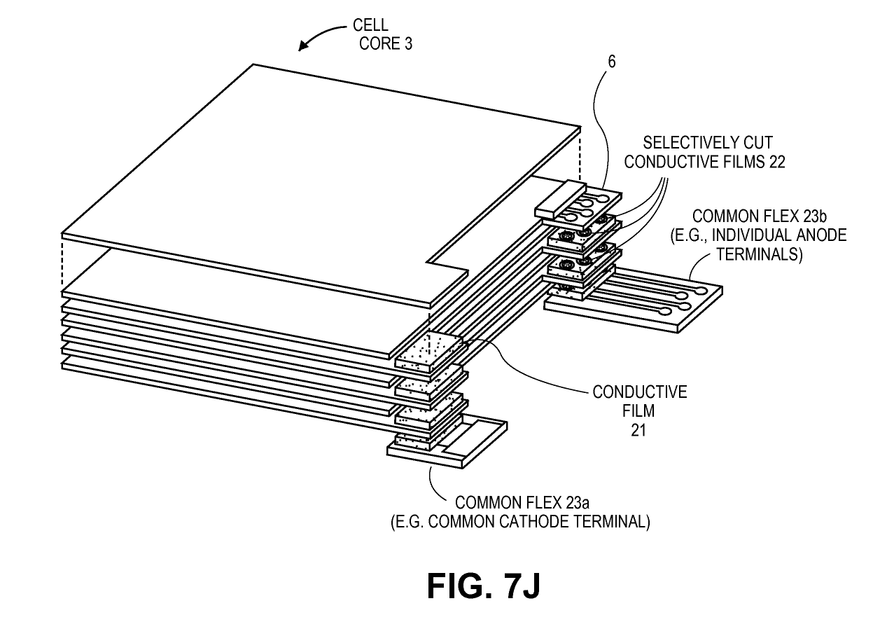

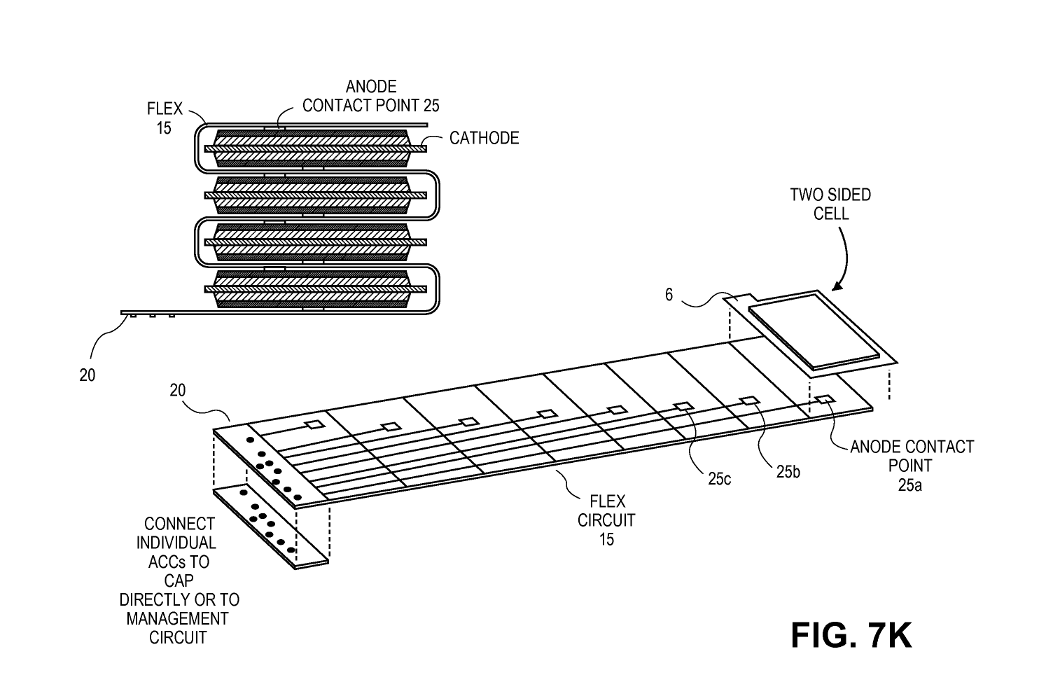

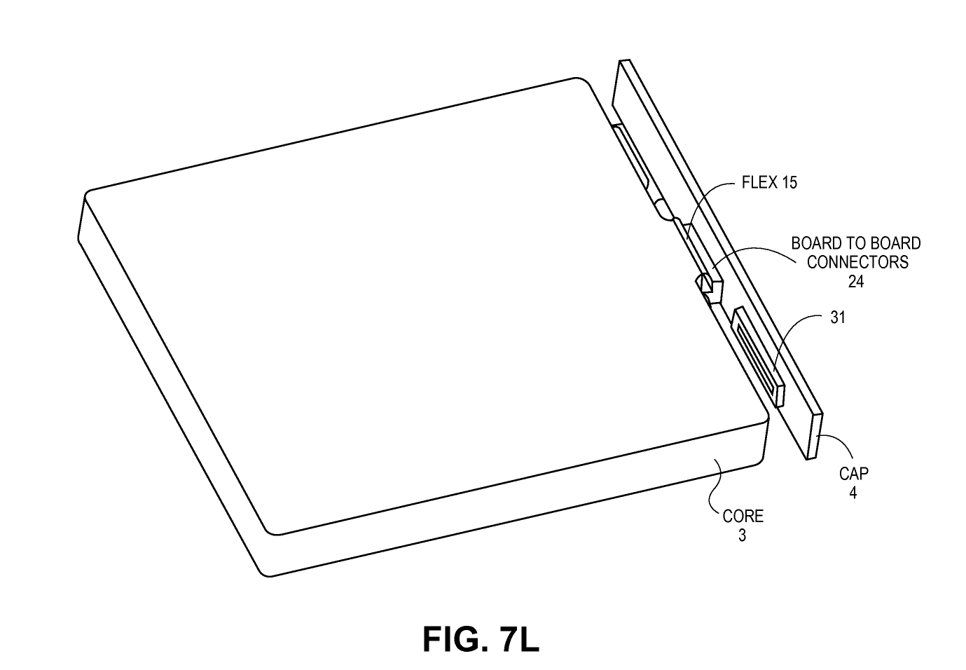

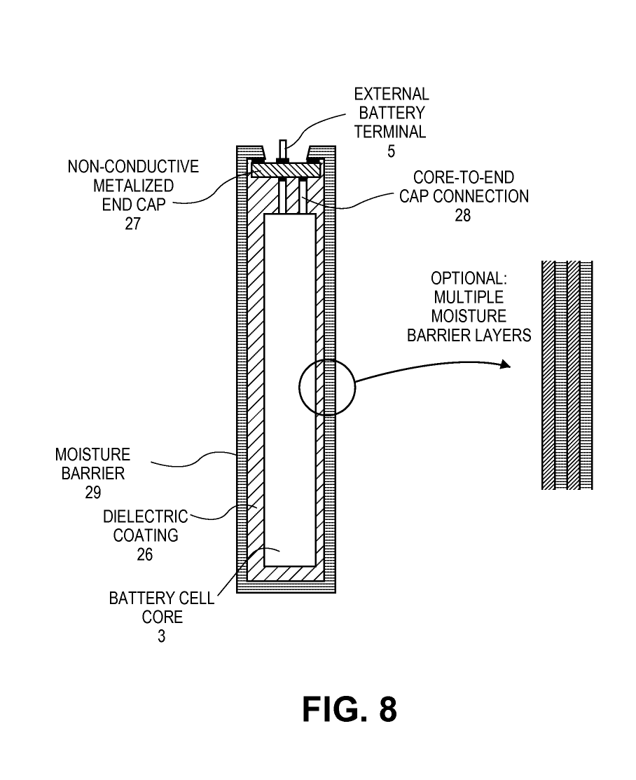

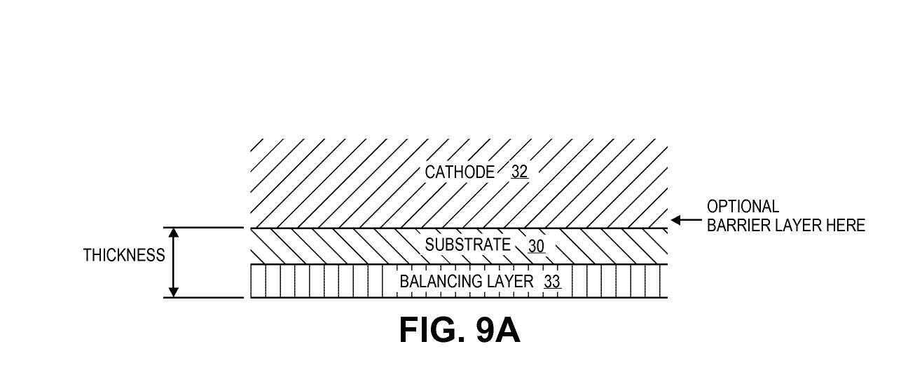

In still other variations, the management circuit 12 may be imbedded inside the cap 4, e.g. within a cavity in the plate 9. In yet other instances, part or all of the management circuit 12 may be installed on a flex circuit inside the battery casing that serves to electrically connect the cell subsets to the conductive paths of the cap 4—see, e.g. FIGS. 7F, 7G described below.

FIG. 6 shows the example of four cell subsets, where each cell subset has a pair of (+) electrodes that are joined to a respective one of the four inner portions 10 of four instances of conductive paths 13 in the cap 4. The current path switches in the management circuit 12 may be used to, for example, disconnect one of these four cells as a failing or undesired cell subset. This may be due to a failure of the cell subset, or due to a request received from an external system for a lower, primary output battery voltage. For example, a parallel connection amongst all four of the cell subsets could be changed to a parallel connection of only three of them while the fourth becomes connected in series, to thereby increase the primary output voltage at the external terminals 5a, 5b. In another embodiment, the management circuitry can monitor, during charging, the current into the individual cell subsets, and may compare them to each other in order to detect which cell is “leaking” and hence may be likely to fail. The circuitry may include an integrated circuit chip or die that is attached to either the inside surface of the cap 4 or to its outside surface as shown, or is imbedded in the cap 4, or it may be located further inward inside the can, e.g. within the space between the tabs of two adjacent cells or stacklets. While described above with respect to four cell subsets, it should be appreciated that the aforementioned benefits may be achieved with any suitable number of cell groupings.

In some instances, it may be desirable to electrically connect electrode layers of two or more cells to each other. For example, in some variations where the battery cores described above have one or more cell groups (e.g., two or more cells), the anode layers of the cells of a cell group may be connected to each other and the cathode layers of the cells of a cell group may be connected to each other. In other instances, where the positive terminals or negative terminals of multiple cell subsets are connected to a shared conductive pathway, the anode layers of one cell subset may be connected to the anode layers of another cell subset, or the cathode layers of one cell subset may be connected to the anode layers of another cell subset. FIGS. 7A-7E depict various manners by which a common connection to multiple electrode or pole layers may be made. For example, referring now to FIGS. 7A, 7B, techniques for making electrical connections between adjacent cells of a cell group, e.g. in a thin film stack of the battery core 3, is shown. The stack-type core 3 can be made up of a stack of pole layers 16, (which may form a rectangular prism shape, such as depicted in FIG. 1, or other shape as described above) which is to be inserted into a similarly dimensioned can 2 (which may be a rectangular prism or other shape such as discussed above). To make efficient use of the volume inside the can 2, electrical current path connections between the positive (+) pole layers 16 of adjacent cells or stacklets (in order to obtain a parallel connection between the cells) can be made as follows. First, a corner piece is removed from each active layer of a pair of adjacent active positive layers to result in cut ends (FIG. 7A top). The cut ends are then joined after folding their end portions towards each other, as shown in the bottom drawing of FIG. 7A. The joint at the folded end portions may be made, for example, via solder, weld (thermal or ultrasonic), or conductive glue (e.g., conductive epoxy). FIG. 7B shows how a wire bond or solder paste connection may also be added as a bridge, to conductively bridge the gap between two non-adjacent active layers 16 (whose corners have been folded in opposite directions). These techniques may enable the resulting battery stack to consistently remain within the allowed dimensions of the tight fitting can 2 into which it will be inserted. Tabs or cell terminals 6a, 6b shown as emerging from their respective (+) and (−) electrode layers 16 (which layers have been otherwise joined to other electrode layers of adjacent cells or cell groups, for example using the folded corner joints) can then be joined to their respective conductive paths in the cap 4 (e.g., as in any one of the techniques described above in connection with FIGS. 5A, 5C and FIG. 6).

In FIGS. 7C-7E, different ways of making a common connection to multiple electrode or pole layers 16 are shown. A group of so-connected cells or groups of cells can then be connected to a conductive path of the cap 4, via for example any of the tab approaches described above in connection with FIGS. 5A, 5C and FIG. 6. Starting with the embodiment of FIG. 7C, one or more edges of a given electrode layer 16a (e.g., at one or more corners, in the case of a layer having a generally polyhedron shape) may be folded down so as to touch or almost touch another electrode layer that is below (e.g., an “adjacent” electrode layer 16b, where adjacent in this case means that the folded edges of the adjacent electrode layers are not separated by another folded edge). A joint may then be made at the adjacent folded edges so as to create, for example, a cathode-to-cathode or an anode-to-anode connection for the two layers. This approach may continue so that more than two layers 16 are connected to each other, to form a common electrical connection. The joints or contact points at the folded edges may be welded or bonded with conductive adhesive or other suitable technique to make a reliable electrical connection between the layers.

In FIG. 7D, a portion of a battery core 3 is shown that is made up of a stack of three cathode layers 16a, 16c, 16e that are interleaved with two anode layers 16b, 16d. These layers are generally of a polyhedron shape, and in particular rectangular in this case, where each layer has a number of corners. A set of such corner regions are aligned with each other as shown, such that for each set one group of pole layers are recessed or cut back relative to the corners of the complementary pole layers, in order to not interfere with a conductive structure 17 at the corner region comprised of in this case the combination of a conductive post and conductive adhesive. This results in a vertical electrical connection being made between same type layers, at each corner. In the example shown, there are four sets of aligned corners, where two of the sets are used to connect the cathodes to each other, while the other two are used to connect the anodes to each other. The core structure may also have cell terminals 6a, 6b as tabs or extensions of an anode layer and a cathode layer as shown, which will be used to make connections to the conductive paths that are formed in the cap 4 (not shown). While the figure shows a post of wire that may be advanced through a via, for example, other conductive structures 17 that may achieve such a vertical electrical connection could be used. While both the anode layers and cathode layers are shown in FIG. 7D as being connected, this connection mechanism may be used to connect only the cathode layers or only the anode layers of a given group of cells. For example, in some variations, this mechanism may be used to connect cathode layers of multiple cell subsets, while the anode layer(s) of each cell subset are individually connected to the conductive paths of the cap 4, or vice versa.

As to FIG. 7E, this is also a perspective view of a core 3 being a battery stack core of multiple layers 16, where in this case again the complementary (first and second) pole layers are interleaved. In this case, each of the first pole layers 16c, 16e, 16g has a notch 19 through which a respective one of several wire bonds 18 passes, where the wire bond 18 connects the first pole layer 16g to another first pole layer 16e below. With this technique, some of the layered structure above a given first pole layer 16c, 16e, 16g may have to be recessed or cut back so as to not interfere with the wire bond 18 that is attached to the top surface of that first pole layer (and that runs down though the notch 19 formed in the first pole layer before joining the top surface of an adjacent first pole layer below). In this structure, similar to FIG. 7D, a tab or cell terminal 6 may be formed on one of the joined first pole layers 16a so as to provide the common electrical connection to a conductive path in the cap 4 (not shown).

Referring now to FIGS. 7F-7L, these figures are used to illustrate different ways of connecting multiple cell subsets (e.g., cells or cell groups) individually to the cap 4, in order to allow for the addressing of each cell subset individually by a management circuit 12 (as mentioned above). As described above, in some of these instances, the same-type pole layers of each cell subset of a battery core 3 can be individually connected to their respective conductive paths in the cap 4. In other words, multiple conductive paths in the cap 4 are connected to multiple cell electrodes (e.g., anodes), which may be those of a single cell subset. In other instances, the cathodes of multiple cell subsets may be commonly connected to each other, and in that case a connection may be made to a single conductive path (or a group of joined conductive paths to increase current capacity) formed in the cap 4, while the anodes of the individual cell subsets are individually connected to their respective conductive paths in the cap 4. The latter approach may still provide individual control or monitoring of cells. Note that a complementary arrangement is possible as well, where the anodes of multiple cells or groups of cells are commonly connected to each other and then to a single conductive path in the cap (or to multiple joined paths for greater current capacity), while the cathodes of those cells or groups of cells are individually connected to their respective, conductive paths in the cap. The common connections between cell subsets may be made in any manner or combination of manners such as described above with respect to FIGS. 7A-7E.

FIGS. 7F-7L present options for connecting individual cell subsets to the cap 4. In some instances, the cell subsets are individually connected to one or more flex circuits, which may in turn be connected to the battery casing. FIG. 7L depicts one such example. As shown there, the cell subsets may be connected to a flex circuit 15, which may in turn be connected to a board to board type of connector 24 (that is installed on the cap 4 as shown in FIG. 7L). The connector 24 is on an inside surface of the cap 4 as shown, and its terminals or contacts may be connected via a number of conductive vias, respectively, to another connector 31 that is either embedded within the cap 4 or external to the cap 4, depending on where the management circuit 12 (described above with respect to FIG. 6) is to be located (as the management circuitry may then connect through the other connector 31, thereby being able to individually address the cells or cell groups).

In some variations, one or more cell subsets may be wire bonded to one or more flex circuits. FIGS. 7F-7H depict options for wire bonding the cell subsets individually to one or more flex circuits. In some instances, the individual cell subsets may be wire-bonded to a single flex circuit (e.g., individual cell subsets may be connected to different traces of the flex circuit, while groups of cells within a cell subset or commonly connected cell subsets, e.g. common cathodes may be connected to a common trace of the flex circuit). FIG. 7F shows a way to make connections between electrode layers of a battery core stack, namely using wire bonds 18 that at one end are joined to the faces of the cell pole (electrode) layers 16 or their associated cell terminals 6, and at another end to a flex circuit 15. This allows individual connections to be made to the cell subsets through different traces formed in the flex circuit 15, as well as common connections to cell subsets through a common trace in the flex circuit 15. The traces are gathered at a connector end 20 of the flex 15 as shown, which may be attached to conductive paths of the cap 4 through a connector 24 as shown in FIG. 7L.

While FIG. 7F shows the various layers being connected to a single flex circuit 15, different electrode layers may be connected to different flex circuits. For instance, in FIG. 7G, anode layers of cell subsets are connected to a first (anode) flex circuit 15b while cathode layers of cell subsets are connected to a second (cathode) flex circuit 15a. In this case, wire bonds 18, at one end, are joined to the edges of the electrode layers, and another end are joined to a flex 15. In the embodiment shown there, the anode flex circuit 15b has multiple traces (one for each anode or anode group) while the cathode flex circuit 15a has a single trace (for common cathode connection). Other combinations of routing the connections to the cell layers through multiple flex circuits are possible. For example, it should be appreciated that the cathode flex circuit 15 may have multiple traces (one for each cathode or cathode group) in instances where it is desirable to have individual connections to different cathode layers.

In some instances, the battery core 3 may have one or more rounded corners (such as mentioned and described above), which may result in added unused space within the can 2. In these instances, referring now to FIG. 7H, it may be desirable to position the wire bonds 18 that connect the cell layers to a flex circuit 15, in these corner gaps, to efficiently use the available space. While the wire bonds 18 that connect a flex circuit 15 to the cell layers of the core 3 may be positioned at the front corners (the corners facing the cap 4), the wire bond 18 may also, or alternatively, be positioned at one or more of the back/rear corners in which case the flex circuit 15a or 15b may wrap around a portion of the core 3 as shown (and this in some instances may add structural integrity to the core 3).

In other instances, as shown in FIG. 7I, the cell subsets of the battery cell core 3 may have cell terminals 6 (e.g., tabs) that are connected to respective traces of a flex circuit 15. The cell terminals 6 or tabs in this instance may have different lengths in order to reach the flex circuit 15, although in other instances the flex circuit 15 may be larger such that the various tabs do not need to have different lengths to reach their traces. In FIG. 7I, there are two batches of cell terminals 6 or tabs connected to the flex 15, one extending upward from the circuit traces in the flex 15, and one downward. In other instances, there may be a single set of tabs, directed upward for example, in which case the flex circuit would be positioned at the bottom of the core 3. Conversely, there may be a single set of tabs connected to the flex 15 that are directed downward, in which case the flex 15 would be positioned at the bottom of the core 3.

In still other instances, referring now to FIG. 7J, the cell terminals 6 or electrode tabs may incorporate either a flex circuit portion or a flex circuit trace, which is then connected in the vertical direction through multiple cell terminals 6 or tabs below, to a common flex circuit 23a, 23b. In some of these instances, a conductive adhesive film 21, 22, e.g. anisotropic conductive film, ACF, may be used to connect the adjacent tabs of the different layers, to provide conductivity through the tabs. The films 22 used to vertically connect the cell terminals 6 that have multiple traces in them may be selectively cut to provide in effect a respective conductive “column” for each trace (down to the common flex 23b). There may be one common flex circuit 23a that provides a common cathode connection, and another common flex circuit 23b that provides individual anode connections as shown. Of course, other combinations of routing connections from cell layer terminals 6 or tabs to one or more of such common flex circuits 23a, 23b are possible.

In still other instances, such as shown in FIG. 7K, a flex circuit 15 may be wrapped around the top and bottom faces and a side of several cell subsets, to provide the connections to the individual layers. In these specific embodiments, the flex circuit 15 may have a number of contact points 25a, 25b, . . . (each of which is connected to a respective trace) located such that each can be joined with an anode of a separate cell subset, as the flex circuit 15 is wrapped around the cell subsets. Although the cell subsets are shown as two-sided cells (for greater efficiency using this embodiment), this embodiment may also be used with one-sided cells or with groups of stacked cells. The conductive traces extend along the length direction of the flex circuit 15 as shown until they reach a connector region 20 of the flex circuit 15 which is to be electrically connected with the conductive paths formed in the cap 4 (e.g., through a connector 24 that is installed on the cap 4, as shown in FIG. 7L). Note that in instances where there are two-sided cells, it may be necessary to connect the cathode tabs using another mechanism as already described above, such as where the cell terminals 6 or tab extensions of the cathodes (e.g., a cathode current collector) emerge beyond the side of the flex 15 as shown in FIG. 7K. Viewed another way, this embodiment comprises cell electrodes that are elements of a number of electrochemical cell subsets, respectively, and a flex circuit is wrapped sequentially around a) a top face, a left side, and a bottom face of a first one of the cell subsets, and then b) a top face, a right side, and a bottom face of an adjacent, second one of the cell subsets, wherein the flex circuit has a number of traces therein each of which terminates in a respective contact point that is positioned so as to be joined with the top face or the bottom face of the first one or the second one of the cell subsets. It should be appreciated that the arrangement described with respect to FIG. 7K may be reversed such that the cathode layers are connected to the contact points 25a, 25b, . . . of the flex circuit 15 while the cell terminals 6 or tabs are anode extensions that are connected to each other using another mechanism such as described here.

In still other instances, the individual cell subset electrodes may be connected directly to the cap 4. In some instances, the electrodes may be wire bonded to the cap 4, such as in FIGS. 7F-7H, but directly to the cap 4 instead of via an intermediate flex circuit. In some instances, cell terminals 6 (e.g., tabs) may be bonded or otherwise placed in contact with conductive vias of the cap 4 (see FIG. 3A). In some instances, an anisotropic conductive adhesive may be positioned between such tabs and the cap 4, which may help to prevent inadvertent connections between the tabs and other vias of the cap 4.

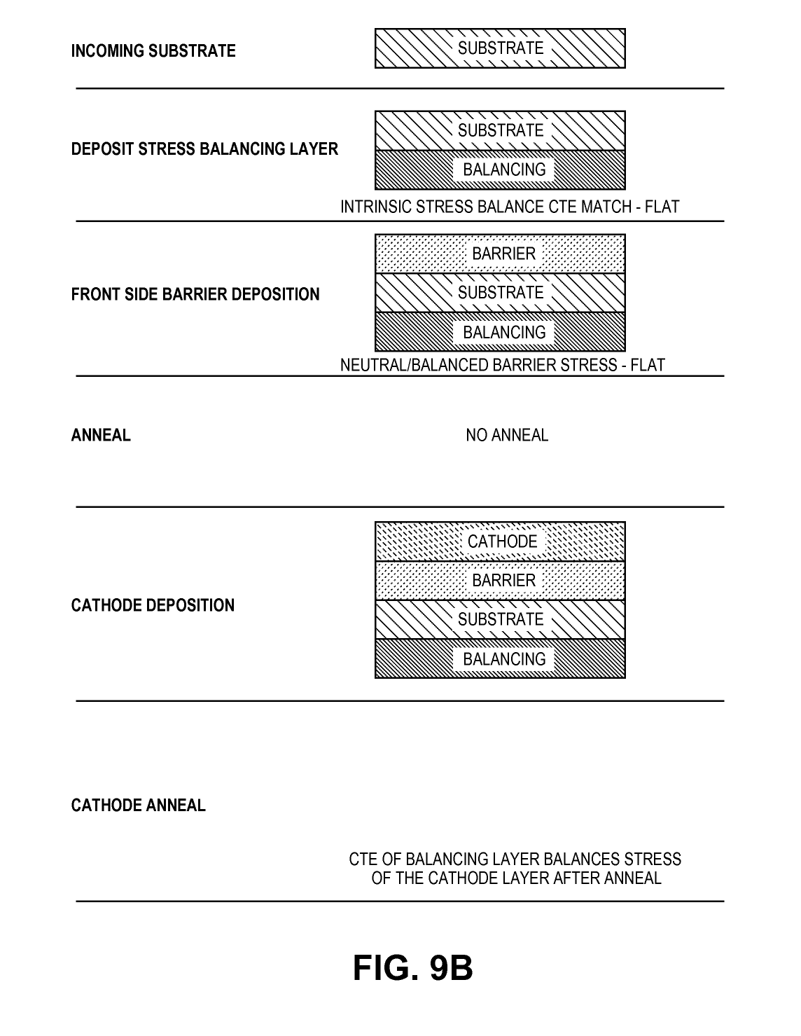

Turning now to FIG. 8, a sectional view of a hermetically sealed or encapsulated battery core is shown, in accordance with another embodiment of the invention. This technique is also referred to as an integrated or in-situ formed casing, where the battery cell core 3 (e.g., thin film stack) is coated with a dielectric film or coating 26, by, for example, dipping the battery core 3 into a solution with the desired insulation materials or via vapor deposition or spraying, for example. The material used may be organic, or it may be an inorganic ceramic material. Coating the core 3 in this manner achieves electrical insulation of the core as well as providing some moisture and oxygen protection. Prior to applying the dielectric coating 26, however, electrical interconnects also referred to here as core to end-cap interconnects 28 may be made, in this example by making an electrical connection between cell terminals of the core 3 and external terminals 5, through a non-conductive, metalized end-cap 27. Note however that the end-cap 27 is optional in this embodiment, depending on the subsequent moisture and oxygen barrier layer 29 that is chosen, as well as external system requirements. If the end cap 27 is provided as shown in FIG. 8, then the dielectric coating 26 may serve to also electrically insulate the exposed metal that is found on the rear surface of the cap 27, which directly contacts the connections 28.

After having applied the dielectric coating 26, and with the end-cap 27 being held in position as shown, a moisture and oxygen barrier layer or skin 29 is applied, which is also described as an external moisture and oxygen barrier in that it prevents oxygen and moisture in the outside environment from reaching the battery core 3 and thus takes the place of the conventional metal foil laminate-based pouch. The moisture and oxygen barrier skin 29 may be made of an inorganic material (e.g., a metal, ceramic, or oxide for example). The moisture and oxygen barrier skin 29 may be achieved by, for example, dipping the dielectric coated battery core into a suitable solution having the inorganic material therein, by vapor deposition, by spraying, by electroforming, or by metallization. It should also be noted that multiple moisture and oxygen barrier layers may be applied in this manner, to further insulate the battery core 3 from environmental elements and/or provide more structural rigidity to the finished battery.

The external battery terminals 5 shown in FIG. 8 may be formed integrally with the conductive traces that are within the end-cap 27 (also referred to here as the external battery connector), as part of the creation of the end-cap 27, and prior to making electrical contact between any terminals exposed on the rear face of the cap 27 and the core to end cap connection 28 (e.g., cell terminals or extensions also referred to as cell tabs). Note that the front or outside surface of the cap 27 may have an optional metalized portion around its periphery as shown which can be plated or coated with the moisture and oxygen barrier skin 29 during application of the latter, in the case that the moisture and oxygen barrier skin is a metal. Finally, although not shown in FIG. 8, an additional external coating may be applied to the moisture and oxygen barrier skin 29 (similar to one that is shown in FIG. 5C and in FIG. 6) depending upon the type of moisture and oxygen barrier skin used and the system requirements. It may be, for example, a dielectric material or other electrically insulating material, and may be needed for cosmetic purposes or it may be needed for mechanical and structural strength reasons. Such an external coating may be deposited by a number of means including, for example, spraying, vapor deposition, and dipping into a bath.

The arrangement in FIG. 8 may be achieved using the following combination of materials for the various coatings: the dielectric coating 26 may be formed through a chemical vapor deposition (CVD) process using Parylene; next, the moisture and oxygen barrier skin 29 may be formed through physical vapor deposition of an aluminum metallization; and finally the optional external electrical insulation coating may be a similar Parylene CVD coating.

In another implementation of the arrangement in FIG. 8, the process may begin by Parylene CVD coating of the battery cell core 3 to form the dielectric coating 26, followed by physical vapor deposition of an aluminum seed layer to form the barrier skin 29, and then followed by an anodization process. An alternative here is to use a seed nickel layer and grow the layer in thickness, using nickel electroplating. It should be noted that the films and coatings described above in connection with an embodiment of FIG. 8 could range in thickness from several angstroms or nanometers up to a millimeter or so.

An alternative to the process described above (in connection with FIG. 8) of using metallization for the moisture and oxygen barrier skin 29 is to use a dense ceramic coating (as the moisture and oxygen barrier skin). Also as suggested above, the end-cap 27 may be omitted in certain situations, for example, when an external connector or an external battery terminal 5 that is electrically connected to the cell terminals has been electrically insulated, so that the metal moisture and oxygen barrier skin 29 may be applied directly to coat it. However, it should be noted that providing the end-cap 27 in many instances helps maintain uniform external dimensions or size for the finished battery, especially during high volume manufacturing. In the case where the end-cap 27 is provided, a preformed metallization as shown in FIG. 8 can be applied to the outside surface of the end-cap 27 and to which the in-situ metal moisture and oxygen barrier skin 29 can be directly plated. In some instances, the end-cap 27 may be attached to the cell terminals of the battery stack (connection 28) to form a battery stack and cap assembly, prior to applying the moisture and oxygen barrier skin 29.

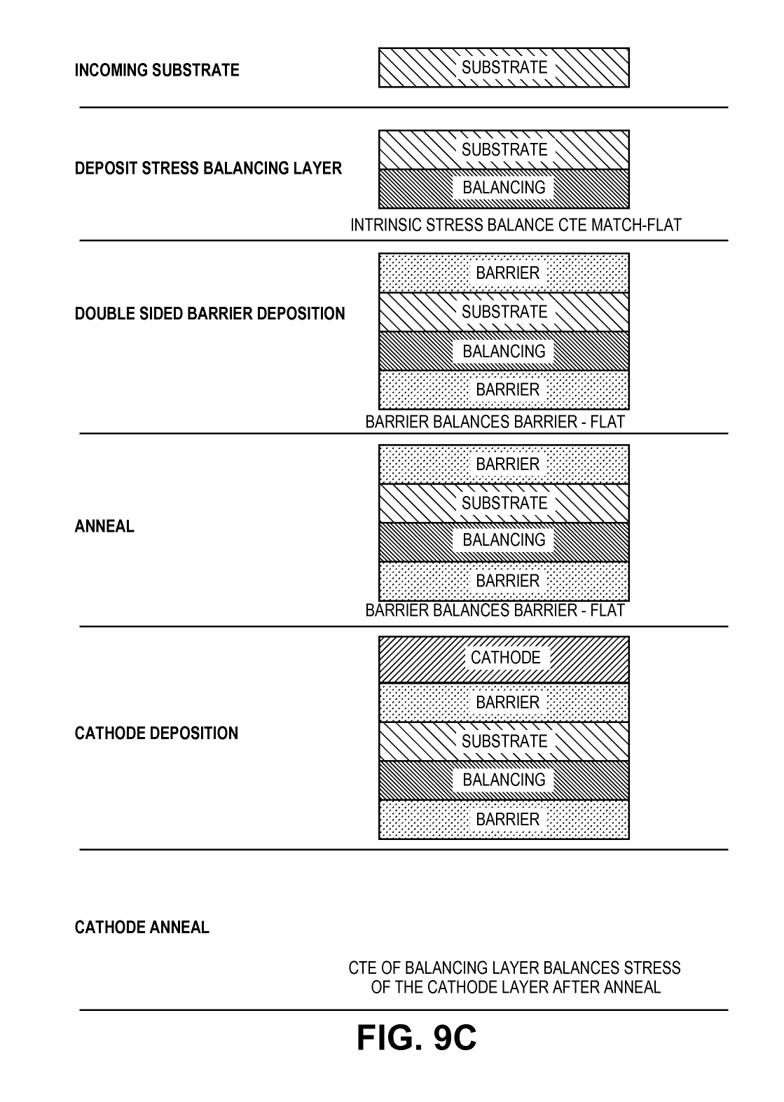

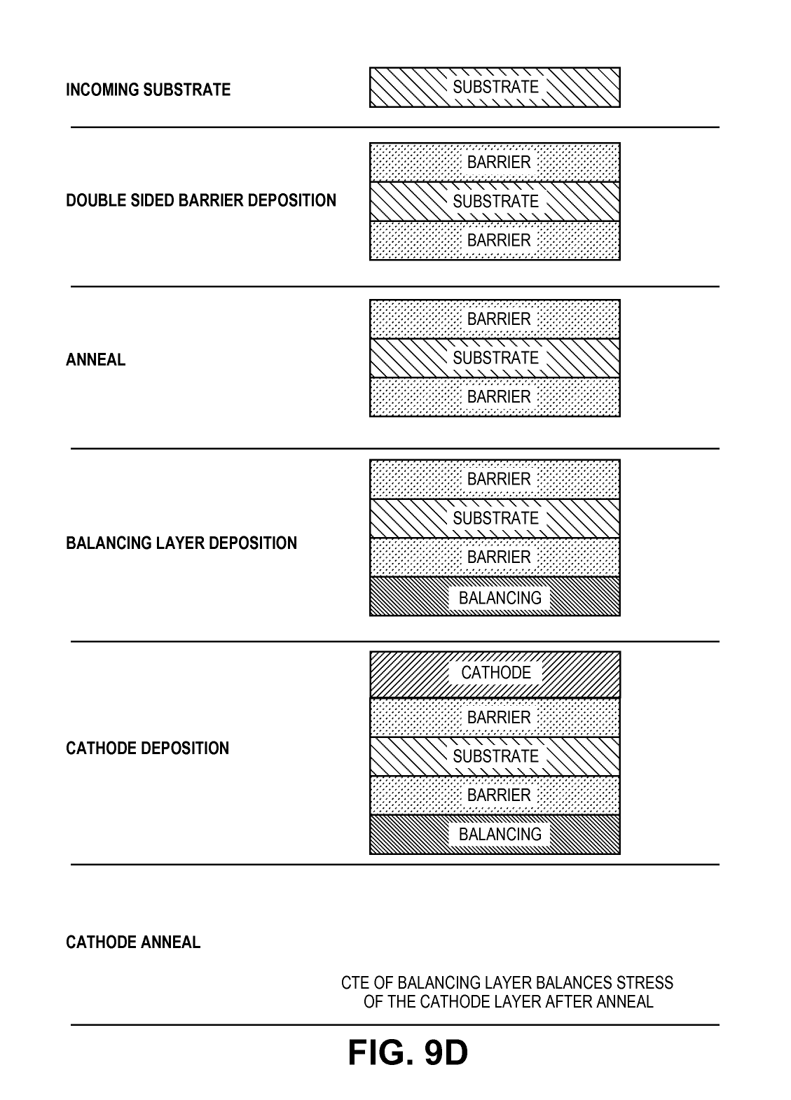

Generally, it may be desirable to produce thin film battery cells that may maintain a flat configuration. For example, when the above-described techniques for hermetically encasing a battery cell core 3 using the metal can 2 are to be applied to a thin film battery stack, a fairly flat battery stack structure is desirable (rather than one that exhibits bends or curves for example in the substrate layer), so as to maximize the usage of the inner volume of the can 2 and in some cases ease insertion of the stack into the can 2. It has been discovered, now referring to FIG. 9A, that during fabrication of a thin film battery stack, a substrate 30 that is used to support a film or layer of the active material, in particular, the cathode film 32, may be subject to tensile or compressive stress during vapor deposition, for example, of the cathode film 32 or during other processing steps. It is possible that such compressive or tensile stress in the cathode film 32, and a complementary stress in the substrate 30, is produced due to a coefficient of thermal expansion (CTE) mismatch between the cathode film 32 and the substrate 30, as well as due to a volume change in the cathode film, during densification and crystallization of the cathode material. This may be the case in situations, for example, where the cathode film is deposited initially in an amorphous state and then subsequently needs to be annealed (for recrystallization into the correct crystal structure). In some instances, the film deposition and anneal may occur simultaneously or in alternating fashion. These processes may lead to an unbalanced bending moment in the film stack as a whole. An unconstrained film stack may curve or bend upwards for example (in the orientation shown in FIG. 9A). Alternatively, if the CTE of the substrate 30 is lower than the cathode film 32, the stack may bow downward. Such substrate curvature may negatively impact the ability to handle the cells, their stacking efficiency, encapsulation, and ultimately the core energy density of the finished battery.

One possible solution for avoiding the formation of “potato chip” style film stacks is to use a double-sided cathode deposition technique. In this case, a thin substrate may be laid flat and then subjected to vapor deposition onto both its top surface and its bottom surface, thereby creating a substrate with a double-sided cathode arrangement (a cathode film or layer 32 on the top face of the substrate 30 as shown in FIG. 9A and also another one on the bottom face of the substrate 30). These two cathode structures are thus simultaneously deposited and may also then be simultaneously annealed and cooled, thereby enabling the structure as a whole to stress balance itself and avoid the curvatures described above.

In another possible solution to the substrate curvature problem, a stress balancing layer 33 is applied to the back surface of the substrate 30 as shown in FIG. 9A. This may be a film of a non-cathode material that is deposited onto the backside (or here, bottom face) of the substrate 30, prior to application of the cathode 32 to the front side (or here, top face), e.g. via cathode deposition onto the front side surface or onto an optional barrier layer. The balancing layer 33 need not be an active cathode material film, and may be much thinner than the cathode film yet should be able to develop about the same amount of compressive stress in the substrate 30 (during deposition of the cathode and its subsequent annealing). The balancing layer 33 can be grown and annealed simultaneously with the cathode 32, for example, by transforming a deposited nickel layer (which may be directly on the substrate surface) into a nickel oxide layer during the anneal of the cathode film. It is possible that the balancing layer 33 may act as the dielectric layer that was described above in connection with FIG. 8 (when forming a hermetically sealed casing for the battery core). This could, for instance, be achieved with a deposited Zr layer that transforms into insulating ZrO2 upon anneal.

In yet another technique (which might also help mitigate substrate curvature), a graded substrate is created from many layers or films, such that during the subsequent annealing process, the CTE of the graded substrate would match that of the active materials of the cathode 32 (to prevent bending of the cathode 32 and/or the substrate 30). Such a graded substrate may have an inert, intermediate barrier layer made of an inert material, in order to reduce the likelihood of ions traveling from the graded substrate up into the cathode film (during deposition of the cathode and its subsequent annealing).

Turning now to FIGS. 9B-9D, these flow diagrams are used to illustrate a few options for providing a stress-balancing layer 33. The different options may have different utility depending on what annealing steps may be used in preparation of the balancing layer 33. Unless otherwise specified, when the following discussion refers to a “layer”, it should be understood that in some cases this encompasses one or more sub-layers or component layers that may be of different materials.

The first option, FIG. 9B, may be used in instances where the substrate and barrier layers are not annealed prior to cathode deposition. In these variations, the battery cell may comprise a substrate, one or more barrier layers positioned on a first surface of the substrate, a stress balancing layer positioned on a second opposite surface of the substrate, and a cathode layer positioned on the one or more barrier layers. The general process operations here may have the following sequence as shown: incoming substrate, deposit stress balancing layer (e.g., a film on the backside of the substrate), front side barrier deposition, cathode deposition (may skip an anneal stage between barrier deposition and cathode deposition here), and cathode anneal. In these instances, the stress balancing layer and the barrier layer may be deposited on opposing sides of the substrate, and the cathode (e.g., LiCoO2) may be deposited on the outermost barrier layer. Note here that the barrier layer in particular may be made of two or more sub-layers, for example a Ti Al layer on a surface of the substrate followed by the formation of an outer sub-layer, e.g. a TiAlN layer, on the free side of the TiAl layer. In these instances, the stress balancing layer may be designed to have a CTE (coefficient of thermal expansion) and thickness such that the film balances out stresses in the remaining layers (including the cathode layer) during annealing of the layers. Other processes that result in a battery cell stack having a cathode, a barrier layer, a substrate and a stress balancing layer in that sequence, are possible.

In some instances, it may be desirable to anneal the substrate and barrier layers prior to cathode deposition. For example, in FIG. 9C, the balancing layer is placed on a first side (face) of the substrate. In these instances, the substrate and balancing layer may be CTE matched in order to balance stresses during annealing. A first barrier layer is deposited on the free side of the substrate as shown, and a second barrier layer is positioned on the free side of the backside balancing film—this is referenced in the example of FIG. 9C as a double sided barrier deposition. In some instances, the first barrier layer is the same (in thickness and materials) as the second barrier layer. In other instances, the first and second barrier layers may be matched to balance each other's stresses during annealing. The substrate, film, and first and second barrier layers may be annealed, and should remain flat due to inherent stress matching. The cathode may then be deposited on the first barrier layer as shown, and again annealed. As with the first option described above in connection with FIG. 9B, the balancing layer may balance out the stresses provided by the cathode.

The third option depicted in FIG. 9D differs from the second (FIG. 9C) in that the first barrier layer and the second barrier layer are deposited on opposite sides of the substrate, and then annealed. The balancing layer may then be deposited on the free side of the second barrier layer as shown, and then the cathode may be deposited on the free side of the first barrier layer, and the layers may be annealed.

In one embodiment, a cathode material is used as the stress balancing layer. In other embodiments however, the stress balancing layer may be of a different material than the cathode; examples of possible materials include SiO2, Si3N4, SiON, AlN, W2C, Al2O3, TiO2, TiN, and TiAl.

The following statements of invention are also made. In one embodiment, a battery comprises a battery cell core having a plurality of cell terminals, a metal can inside which the cell core is positioned in its entirety, and a non-conductive cap having a plurality of conductive paths formed therein each of which provides electrical contact between a respective one of the plurality of cell terminals and a respective one of a plurality of external battery terminals outside of the can, wherein the cap covers an opening of the can and a periphery of the cap is bonded to the can at the boundary of the can opening, to seal the opening. In one embodiment, the battery cell core is hermetically encapsulated by the combination of the can and the sealed cap; in one embodiment, no additional hermetic package or encasing is provided between the battery cell core and the can and cap combination.

The can may be a prism having a plurality of faces of which at least one is fully formed and at least one is not fully formed so as to yield a can opening through which the cell core has been inserted into the can. The can opening may be an entire face of the prism such as a side (not face) of the prism, and the cap by itself plugs the entire can opening except for a small gap that is filled with sealant/bonding material so as to hermetically seal the inside of the can. The battery cell core may be a thin film lithium based battery cell stack and the outside thickness or height of the metal can is no more than 5 millimeters. In one embodiment, at least two of the faces are not fully formed so as to yield a) said can opening and b) a further can opening. In another embodiment, the can opening extends to three unformed faces of the prism, and the cap by itself plugs the can opening's three unformed faces. In another embodiment, the can opening extends to two unformed adjoining faces of the prism, and the cap is substantially L-shaped so that by itself the cap plugs the can opening's two unformed adjoining faces.

The can opening may be an entire face of the prism being a top or bottom of the prism, wherein the battery further comprises a further plate (e.g., a metal plate) that together with the cap plug the entirety of the can opening. The metal can may have a rectangular prism shape having six faces of which five are fully formed and one is not fully formed. The metal can could also have an oval prism or a circular prism shape, having a fully formed curved sidewall joined to a fully formed bottom face, and a top face that is not fully formed. The battery can may further comprise a flared region (sections of its walls that are flared) formed around the can opening.

The battery cell core may comprise a plurality of thin film battery cells forming a stack whose height and width are slightly less than inside n- and x-dimensions of the metal can, respectively, so as to allow insertion of the stack while minimizing the gap between the outside surface of the stack and the inside surface of the metal can. In various embodiments, the battery stack comprises entirely flat, not curved, layers of anode, separator and cathode films, wherein the layers are positioned parallel to top and bottom faces of the metal can. In one embodiment, the metal can is dimensioned to minimize space between the thin film battery cell stack and an interior surface of the metal can so that the stack can be inserted into the can through the opening like a cartridge.

The following additional statements of invention are also made. A method for assembling a battery, such as any one of those described above, comprises: inserting a battery cell core into an opening of a metal can; and bonding a periphery of a non-conductive cap to the boundary of the can opening to seal the can. An electrical contact can be made between an external battery terminal that is at least partly embedded in the cap and a cell terminal of the core inside the can, prior to bonding the periphery of the cap to the boundary of the can opening. In one embodiment, the battery cell core is coated with an electrically insulating material, prior to inserting it into the metal can, where the latter may have exposed metal on its interior surface. In another embodiment, the interior surface of the metal can is coated with an electrically insulating material, before the core is inserted therein (and the core in that case need not be coated with an electrically insulating layer). In one embodiment, the core is inserted into the can while the inside volume of the can is a vacuum, which may be needed due to the tight tolerance between the outside surface of the core and the inside surface of the can. This may be achieved by performing the insertion inside a vacuum chamber, or by temporarily creating a hole in a wall (e.g., the rear side wall) of the can through which the vacuum is pulled and then plugging the hole to maintain the hermetic seal once the cap has been installed. In another embodiment, the entire exterior of the can is covered with an electrically insulating coating, after bonding the cap to the can.

Another method for making a battery comprises: coating a thin film battery cell core with an electrically insulating material; and coating the insulated core with a moisture and oxygen barrier skin, e.g. by metallizing the insulated core. In a further operation, an external battery terminal is maintained in contact with a cell terminal of the battery cell core, while coating the core with insulating material which also coats a part of the external battery cell terminal so that metallizing the core avoids creating electrical contact between positive and negative battery cell terminals of the core.

In yet another method for making a battery, a substrate layer is subjected to vapor deposition that forms first and second cathode layers simultaneously on opposite faces of the substrate layer directly opposite each other to form a double-sided cathode structure. The double-sided cathode structure is then annealed.

In yet another embodiment of a method for making a battery (see, e.g. FIG. 9B), a balancing film is formed on a back side of a substrate wherein the balancing film is not an active cathode material but develops a similar stress in the substrate as a cathode structure during one or both of a) deposition of the cathode structure and b) annealing of the deposited cathode structure. The method further comprises a front side barrier deposition operation in which a barrier layer, e.g. as a combination of two or more stacked layers such as a TiAl layer followed by a TiAlN layer, is formed on the free side (here, front side) of the substrate. The method may then continue with cathode deposition (e.g., a layer of LiCoO2) on the barrier layer, without an intermediate anneal operation, followed by a cathode anneal operation.

In yet another embodiment of a method for making a battery (see, e.g. FIG. 9C), once the balancing film is formed on a back side of the substrate, wherein the balancing film is not an active cathode material but develops a similar stress in the substrate as a cathode structure during one or both of a) deposition of the cathode structure and b) annealing of the deposited cathode structure, a double sided barrier deposition operation is performed in which a first barrier layer, e.g. as a combination of two or more stacked layers such as a Ti Al layer followed by a TiAlN layer, is formed on the free side (here, front side) of the substrate, simultaneously with a second barrier layer (which may be similar in composition to the first barrier layer) on a free side of the balancing film. In one embodiment, the method may then continue with an anneal operation, before proceeding with cathode deposition (e.g., a layer of LiCoO2) on the first barrier layer.

In yet another embodiment of a method for making a battery (see, e.g. FIG. 9D), a double sided barrier deposition operation is performed in which a first barrier layer, e.g. as a combination of two or more stacked layers such as a TiAl layer followed by a TiAlN layer, is formed on a front side of the substrate, simultaneously with a second barrier layer (which may be similar in composition to the first barrier layer) on a back side of the substrate. The method may then continue with an anneal operation, and then formation of the balancing film on a back side of the second barrier layer, wherein the balancing film is not an active cathode material but develops a similar stress in the substrate as a cathode structure during one or both of a) deposition of the cathode structure and b) annealing of the deposited cathode structure. The method then proceeds with cathode deposition (e.g., a layer of Li Co O2) on the first barrier layer.

In another embodiment, a battery cell stack comprises: a substrate; a first barrier layer formed on a front side of the substrate; a cathode formed on the first barrier layer; a balancing layer formed on a back side of the substrate, wherein the balancing layer comprises a material other than that of the cathode and develops stress in the stack that tends to balance stress that is developed in the substrate during formation of the cathode; and a second barrier layer formed on the balancing layer.

In yet another embodiment, a battery cell stack comprises: a substrate; a first barrier layer formed on a front side of the substrate; a cathode formed on the first barrier layer; a second barrier layer formed on a back side of the substrate; and a balancing layer formed on the second barrier layer, wherein the balancing layer comprises a material other than that of the cathode and develops stress in the stack that tends to balance stress that is developed in the substrate during formation of the cathode. The material of the balancing layer can be selected from the group consisting of: SiO2, Si3N4, SiON, AI N, W2C, Al2O3, TiO2, TiN, and TiAl.

Another embodiment of the invention is a battery comprising an electrochemical battery cell in which a graded substrate has an active cathode material film formed thereon, wherein the graded substrate is made of a plurality of stacked layers whose materials and stacking order have been selected so as to result in a CTE, for the graded substrate as a whole, that matches a CTE of the cathode film to mitigate bending of the cathode film and/or of the graded substrate during annealing of the cathode film.

In another embodiment of a battery that has a metal can and that is sealed with a non-conductive cap, the battery cell core comprises a plurality of cell subsets made up of a plurality of first pole layers and a plurality of second pole layers complementary to the first pole layers, wherein a separate tab emerges from each of the plurality of second pole layers and is directly joined with a respective one of the conductive paths formed in the cap.

In yet another embodiment of the battery, see for example FIGS. 7A, 7B, the plurality of cell subsets comprise a plurality of first pole layers (1, 2, 3, 4) stacked with a plurality of complementary second pole layers (1,2) in the following sequence: first pole layer 1; second pole layer 1; first pole layer 2; first pole layer 3; second pole layer 2; and first pole layer 4, wherein the first and second pole layers have a plurality of corners, respectively, that are aligned with each other, the corners of the first pole layers 1, 2 are folded towards and joined to each other, and the corners of the first pole layers 3, 4 are folded towards and joined to each other.

In another embodiment of the battery, see for example FIG. 7J, the plurality of cell subsets comprise a plurality of pole layers and wherein a plurality of electrically insulating tabs emerge from the pole layers, the tabs being aligned vertically with each other, wherein each of tabs has a plurality of traces formed therein that connect to respective ones of the pole layers, and wherein adjacent ones of the aligned tabs are connected to each other by a conductive film that has selectively cut regions therein that align with the traces, respectively, the battery further comprising a flex circuit that has a plurality of traces therein which are connected to an adjacent tab, and wherein the flex circuit is further connected to the conductive paths in the cap.

In yet another embodiment of the battery, see, e.g. FIG. 7K, a flex circuit is wrapped sequentially around a) a top face, a left side, and a bottom face of a first one of the cell subsets, and then b) a top face, a right side, and a bottom face of an adjacent, second one of the cell subsets, wherein the flex circuit has a plurality of traces therein each of which terminates in a respective contact point that is positioned so as to be joined with the top face or the bottom face of the first one or the second one of the cell subsets.

In the cases where a flex circuit is used, the flex circuit may be connected to the conductive paths of the cap directly, or a connector may be installed on an inside surface of the cap wherein the flex circuit in that case is connected to the conductive paths of the cap through the connector. There may be another connector that is installed on an inside surface of the cap and to which the battery management circuit is connected inside the casing.

While certain embodiments have been described and shown in the accompanying drawings, it is to be understood that such embodiments are merely illustrative of and not restrictive on the broad invention, and that the inventions are not limited to the specific constructions and arrangements shown and described, since various other modifications may occur to those of ordinary skill in the art. For example, the outside surface of the cap 4 need not be entirely flat but instead may have features such as a tongue that extends out to provide a horizontal platform on which an integrated circuit or other electrical components may be installed, or a mechanical attachment mechanism may be formed therein. For example, screw threads or other mechanical connection mechanisms such as snap-fit or elastic interlocks can be built into the platform, so as to enable the finished battery to be attached to chassis of a consumer electronics device, for instance, in which the finished battery is to be integrated. The description is thus to be regarded as illustrative instead of limiting.

What is claimed is:

1. A battery comprising:
a battery management circuit;
a hermetically sealed casing inside which a battery cell core is contained, the core having a plurality of cell subsets, each cell subset comprising at least one battery cell; and
a plurality of conductive paths formed in the casing through which each cell subset is individually connected to the battery management circuit,
wherein the battery management circuit 1) senses individual voltage of each of the cell subsets through the conductive paths to detect a failing cell subset and prevents the failing cell subset from contributing to an output voltage of the battery, and 2) connects one of the cell subsets with another one of the cell subsets in series or in parallel through the conductive paths to change the output voltage of the battery.

2. The battery of claim 1 wherein the hermetically sealed casing comprises a metal can in which the core is held, and a non-conductive cap that covers an opening of the can, with a periphery of the cap being bonded to the can along a boundary of the can opening to seal the opening, and wherein the conductive paths are formed in the cap.

3. The battery of claim 2 wherein some of the conductive paths terminate in a plurality of external battery terminals exposed outside of the cap that provide a primary output voltage of the battery.

4. The battery of claim 2 wherein the cap comprises a non-conductive plate and an edge metallization formed along a periphery of the plate, wherein the cap is bonded to the can along the entirety of the edge metallization to seal the can opening.

5. The battery of claim 4 wherein the non-conductive plate is a ceramic plate, and the external terminal of the battery comprises a printed circuit trace that is formed on an outside surface of the ceramic plate.

6. The battery of claim 4 wherein the non-conductive plate is a ceramic plate, and the plurality of conductive paths formed in the plate comprise through hole vias.

7. The battery of claim 4 wherein the metal can is electroformed having a prism shape, wherein the opening is the only opening of the can and is entirely sealed by the cap being bonded to the can along the entirety of the edge metallization.

8. The battery of claim 2 wherein an interior surface of the metal can is coated with an electrically insulating film, prior to insertion of the battery cell core, so as to electrically isolate the battery cell core from the metal can.

9. The battery of claim 1 wherein the plurality of cell subsets comprise:
a plurality of first pole layers that are stacked with a plurality of complementary second pole layers, wherein the first pole layers have a plurality of corners, respectively, that are aligned with each other and folded in the same direction, and wherein the folded corners of the first pole layers are joined to each other to make a common electrical connection.

10. The battery of claim 1 wherein the plurality of cell subsets comprise:
a plurality of first pole layers interleaved with a plurality of second pole layers complementary to the first pole layers, wherein the first and second pole layers have a plurality of corners, respectively, that are aligned with each other, the corners of the second pole layers being recessed or cut back relative to the corners of the first pole layers, wherein the corners of the first pole layers are connected to each other by a conductive post or wire.

11. The battery of claim 1 wherein the plurality of cell subsets comprise:
a plurality of first pole layers interleaved with a plurality of complementary second pole layers in a stack formation, wherein the first pole layers are connected to each other by way of a plurality of wire bonds, respectively, wherein each of the first pole layers has a notch through which a respective one of the wire bonds connects the first pole layer to another first pole layer.

12. The battery of claim 1 wherein the plurality of cell subsets comprise a plurality of pole layers, the battery further comprising a flex circuit positioned inside the can, wherein each of the pole layers is electrically connected though a separate wire bond to a respective conductive trace of the flex circuit.

13. The battery of claim 12 wherein each of the wire bonds has one end joined to an edge of its respective pole layer and another end joined to the respective conductive trace of the flex circuit at a rear region where the flex circuit lies flat against a front side of the core, wherein the flex circuit extends from the rear region to a bend region, where it bends toward the cap, and then to a front region where the conductive traces are exposed so as to connect to the conductive paths in the cap.

14. The battery of claim 12 wherein the wire bonds are positioned at a corner space between an inside corner of the can and a corresponding outside corner of the core, and wherein the flex circuit is connected to the conductive paths of the cap.

15. The battery of claim 12 wherein the wire bonds are positioned at a rear corner space between an inside rear corner of the can and a corresponding outside rear corner of the core, and wherein the flex circuit runs forward along a side of the core to a front of the core where it is connected to the conductive paths of the cap.

16. The battery claim 1 wherein the plurality of cell subsets comprise a plurality of pole layers and a tab emerges from each of the pole layers, the battery further comprising a flex circuit positioned inside the can, wherein each of the pole layers is electrically connected though its respective tab to a respective conductive trace, or to a common conductive trace, of the flex circuit, the tabs being connected to the flex from a top side or a bottom side of the flex.

17. The battery of claim 1 wherein the plurality of cell subsets comprise a plurality of pole layers and wherein a tab emerges from each of the pole layers, the tabs being aligned vertically with each other, wherein adjacent ones of the aligned tabs are connected to each other by a conductive bond, the battery further comprising a flex circuit that has a trace therein which is connected to one of the tabs via a conductive bond, wherein the flex circuit is further connected to one of the conductive paths in the cap.

18. A battery comprising:
a battery cell core having a plurality of cell electrodes;
a metal can in which the battery cell core is positioned; and
a non-conductive cap having an edge metallization along the entirety of its periphery, wherein the cap covers an opening of the can with the edge metallization being bonded to the can along the entirety of the periphery to hermetically seal the can.

19. The battery of claim 18 wherein the non-conductive cap comprises a plurality of conductive paths formed therein each of which electrically connects a respective one of the cell electrodes inside the can through the non-conductive cap with an external terminal of said battery that is exposed outside of the can.

20. The battery of claim 19 wherein the cap comprises a ceramic printed circuit board in which the conductive paths are formed as through hole vias.

21. The battery of claim 19 further comprising a battery management circuit,
wherein battery cell core comprises a plurality of cell subsets, and the non-conductive cap comprises a further plurality of conductive paths formed therein which at one end are connected to the cell subsets and at another end connected to the management circuit, wherein the management circuit through the further conductive paths 1) senses individual voltages of the cell subsets and 2) connects individual ones of the cell subsets to form series and parallel connections between the cell subsets.

22. A battery cell stack comprising:
a substrate;
a cathode formed on a front side of the substrate; and
a balancing layer formed on a back side of the substrate, wherein the balancing layer comprises a material other than that of the cathode and develops stress in the stack that tends to balance stress that is developed in the substrate during formation of the cathode.

23. The battery cell stack of claim 22 further comprising a barrier layer formed between the front side of the substrate and the cathode.

24. The battery cell stack of claim 22 wherein the material of the balancing layer is selected from the group consisting of: SiO2, Si3N4, SiON, AlN (aluminum nitride), W2C, Al2O3, TiO2, TiN, and TiAl.
